(19) United States
(12) Patent Application Publication
(10) Pub. No.: US 2026/0264555 A1
(43) Pub. Date: Sep. 10, 2026

(54) CHARGING SYSTEM FOR HUMANOID ROBOT

(71) Applicant: Figure AI Inc., San Jose, CA (US)

(72) Inventors: Ryan Benyshek, San Jose, CA (US); Basel Zohny, San Jose, CA (US); Adeel Zaheer, San Jose, CA (US); Sydney Hardy, San Jose, CA (US)

(21) Appl. No.: 19/557,667

(22) Filed: Mar. 5, 2026

Related U.S. Application Data
(60) Provisional application No. 63/875,558, filed on Sep. 4, 2025.
(60) Provisional application No. 63/874,723, filed on Sep. 3, 2025.
(60) Provisional application No. 63/875,074, filed on Sep. 3, 2025.
(60) Provisional application No. 63/850,760, filed on Jul. 25, 2025.
(60) Provisional application No. 63/839,479, filed on Jul. 7, 2025.
(60) Provisional application No. 63/839,474, filed on Jul. 7, 2025.
(60) Provisional application No. 63/767,281, filed on Mar. 5, 2025.

(51) Int. Cl. B60L 53/62; B60L 53/12; B60L 53/66; H02J 7/34; H02J 50/10; H02J 50/40; H02J 50/80

(52) U.S. Cl. CPC B60L 53/62; B60L 53/12; B60L 53/66; H02J 7/342; H02J 50/10; H02J 50/402; H02J 50/80; B60L 2210/30

(57) ABSTRACT

A charging system for a plurality of humanoid robots, including a plurality of charging mat assemblies, each charging mat assembly including at least one transmitter coil assembly configured to generate an oscillating magnetic field for wireless power transfer to a humanoid robot when the humanoid robot stands on the charging mat assembly, and a centralized electronics assembly coupled to each charging mat assembly in the plurality of charging mat assemblies via a respective tether cord. The centralized electronics assembly includes a communications transceiver configured to communicate with the plurality of humanoid robots, an AC to DC power converter configured to supply power to the plurality of charging mat assemblies via the respective tether cords, and a controller configured to independently control power allocation from the AC to DC power converter to each charging mat assembly in the plurality of charging mat assemblies.

### CROSS REFERENCE TO RELATED APPLICATIONS

This application claims the benefit and priority to U.S. Provisional Application Nos. 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is expressly incorporated by reference herein in its entirety.

### TECHNICAL FIELD

The present disclosure relates generally to charging systems for robotic devices, and more specifically to a wireless (e.g., inductive) charging system that incorporates one or more communication systems. The charging system is designed for use in recharging a humanoid robot within the robot’s operational environment, and the system is further configured to support including opportunistic charging sessions that may occur during various stages of the robot's operation.

### BACKGROUND

The current workplace landscape is marked by an unparalleled labor shortage, evident in over 10 million unsafe or undesirable jobs within the United States. To counter this ever-expanding labor shortage, it has become imperative to design and integrate advanced robots capable of handling unappealing and even hazardous workplace tasks. With the goal of performing these tasks in an optimal and efficient manner, advanced robots are typically general-purpose humanoid robots tailored for human-centric environments. To work in human-centric environments, the general-purpose humanoid robot must include a battery to enable the robot to move from location to location without being coupled to an external power source. To this extent, the general-purpose humanoid robots must be able to recharge their internal batteries. Accordingly, a need exists for an improved charging system that offers safe and enhanced power delivery, superior thermal management, and faster charging within the robot’s operational environment.

### SUMMARY

The presently disclosed subject matter is directed to a charging system for a plurality of humanoid robots. The charging system includes: a plurality of charging mat assemblies, each charging mat assembly includes at least one transmitter coil assembly configured to generate an oscillating magnetic field for wireless power transfer to a humanoid robot when the humanoid robot stands on the charging mat assembly; and a centralized electronics assembly coupled to each charging mat assembly in the plurality of charging mat assemblies via a respective tether cord. The centralized electronics assembly includes: a communications transceiver configured to communicate with the plurality of humanoid robots; an AC to DC power converter configured to supply power to the plurality of charging mat assemblies via the respective tether cords; and a controller configured to independently control power allocation from the AC to DC power converter to each charging mat assembly in the plurality of charging mat assemblies.

The presently disclosed subject matter is directed to an opportunity charging system for wirelessly charging a humanoid robot. The opportunity charging system includes: a base housing having a wireless charging surface and at least one ramped edge extending from the wireless charging surface, the at least one ramped edge is configured to reduce a lift height of a foot of a humanoid robot to step onto the wireless charging surface; a first transmitter coil assembly and a second transmitter coil assembly positioned within the base housing beneath the wireless charging surface, the first transmitter coil assembly and the second transmitter coil assembly are spaced apart in a side-by-side configuration corresponding to a neutral stance of left and right feet of a humanoid robot, and the first transmitter coil assembly and the second transmitter coil assembly are each configured to generate an oscillating magnetic field for wireless power transfer to a respective receiver coil assembly in a respective foot of the humanoid robot; a tether cord extending from the base housing; and an electronics assembly that is physically separate from the base housing and coupled to the base housing via the tether cord, wherein the electronics assembly comprises power conversion electronics configured to supply power to the first transmitter coil assembly and the second transmitter coil assembly via the tether cord.

The present disclosure relates to a wireless charging system for humanoid robots, comprising one or more charging mat assemblies each having a base housing with a flat base platform portion defining a wireless charging surface and at least two transmitter coil assemblies positioned beneath the surface in a side-by-side configuration corresponding to the left and right feet of a humanoid robot in a neutral stance. In alternative embodiments, the transmitter coil assemblies may each include a geometry shaped to correspond to a respective foot of the humanoid robot, and respective centers of the transmitter coil assemblies may be spaced apart by a distance of between 150 mm and 400 mm. In further alternative embodiments, a first transmitter coil assembly may include a coil wound in a first direction and a second transmitter coil assembly may include a coil wound in an opposite direction, such that the respective magnetic fields substantially cancel out far-field emissions. The wireless charging surface may, in alternative embodiments, include a textured surface comprising grooves and projections configured to provide a high-friction contact surface for the feet of the humanoid robot. In alternative embodiments, the base housing may include ramped or beveled edges extending from at least three sides of the wireless charging surface to allow the humanoid robot to step onto the surface from multiple directions with reduced foot lift height, and in further alternative embodiments, the ramped edges may surround the entire perimeter of the wireless charging surface, with a front ramped edge having a more gradual slope than the remaining ramped edges. In alternative embodiments, the upper surface of the base housing on which the humanoid robot stands may be less than or equal to 8 inches from the underlying support surface.

In alternative embodiments involving a plurality of charging mat assemblies connected to a centralized electronics assembly with a shared AC to DC power converter, a controller dynamically manages power distribution across the system. The controller may, in alternative embodiments, receive battery charge levels from individual humanoid robots and determine differentiated power allocations for respective charging mat assemblies based on those charge levels. In further alternative embodiments, the controller may receive task priority information from the humanoid robots and allocate greater power to a charging mat assembly serving a robot with a higher-priority task. In alternative embodiments, the controller may determine the number of humanoid robots actively charging and dynamically adjust power delivery to one or more charging mat assemblies accordingly, and may further monitor aggregate power consumption across all charging mat assemblies and automatically adjust the supply of power to maintain total consumption within a predetermined power consumption limit. In further alternative embodiments, the controller may receive communications indicating that two or more robots will arrive at respective charging mat assemblies for charging substantially simultaneously and, in response, determine a staged startup sequence for the power converter to begin supplying power to the respective charging mat assemblies. In alternative embodiments, the controller may identify an amount of current to be transferred from a first humanoid robot with a higher battery charge level to a second humanoid robot with a lower battery charge level via the centralized electronics assembly, and cause the centralized electronics assembly to execute the transfer. In alternative embodiments, the charging mat assemblies may be deployed within individual workstations for humanoid robots, enabling the robots to execute tasks while standing on the charging mat assemblies, and the plurality of workstations may form a charging bay within a working environment.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3 is a graph showing how the charge level of the battery contained in the humanoid robot may change over a work shift;

FIG. 4 is a perspective view of an array of charging systems, and wherein each charging system is configured to accommodate a humanoid robot;

FIG. 5 is a block diagram showing how power may be wirelessly transferred between the charging system and the battery of the humanoid robot;

FIG. 6 is a block diagram of the electronics contained in the humanoid robot and the charging system of FIG. 4;

FIG. 7 is a perspective view of a charging system that is configured to function with the humanoid robots of FIGS. 1-2;

FIG. 8 is a perspective view of the charging system of FIG. 7, wherein the support frame assembly and the support cradle have been removed to transform the charging system into an opportunity charging system;

FIG. 9 is a perspective view of the opportunity charging system of FIG. 8;

FIG. 10 is a perspective view of a second embodiment of an opportunity charging system;

FIG. 11 is a perspective view of a third embodiment of an opportunity charging system;

FIG. 12 illustrates a perspective view of a plurality of humanoid robots of FIGS. 1-2 working on a factory floor, and wherein a first set of the plurality of humanoid robots are working at workstations that include the opportunity charging system of FIGS. 8-11 that provides wireless opportunity charging capabilities to the humanoid robots; and

FIG. 13 is a perspective view of a fourth embodiment of an opportunity charging system including a centralized electronic control system and a plurality of charging mats;

FIG. 14 is a perspective view of a plurality of humanoid robots of FIGS. 1-2 working on a factory floor, wherein the humanoid robots are working at workstations that include non-portable opportunity charging systems;

FIG. 15 is a flowchart illustrating a method for power allocation in a charging system for humanoid robots based on battery charge levels;

FIG. 16 is a flowchart illustrating a method for dynamically adjusting power delivery to charging mat assemblies based on the number of humanoid robots actively charging;

FIG. 17 is a flowchart illustrating a method for priority-based power allocation in a humanoid robot charging system;

FIG. 18 is a flowchart illustrating a method for implementing a staged startup sequence when multiple humanoid robots arrive simultaneously at charging mat assemblies; and

FIG. 19 is a flowchart illustrating a method for transferring battery charge from a first humanoid robot to a second humanoid robot via a centralized electronics assembly.

### DETAILED DESCRIPTION

In the following detailed description, numerous specific details are set forth by way of examples in order to provide a thorough understanding of the relevant teachings. These examples are illustrative and not exhaustive. However, it should be apparent to those skilled in the art that the present teachings may be practiced without such details. The scope of the teachings is not limited to these specific details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and several details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to "one embodiment," "an embodiment," "an illustrative embodiment," etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of "at least one A, B, and C" can mean (A); (B); (C); (A and B); (A and C); (B and C); or (A, B, and C). Similarly, items listed in the form of "at least one of A, B, or C" can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of autonomously handling undesirable and hazardous tasks, or (ii) advanced robots capable of generating data that can be utilized to develop cutting-edge artificial intelligence models (e.g., LLMs, VLMs, VLAs, and/or BAMs) to enable these robots to operate autonomously in human-centric environments.

One aspect of advanced robotic autonomy is to provide the advanced robot with the capability to replenish its own internal power reserves. As the robot operates, the onboard electrical and electromechanical systems consume power. As such, the robot should be provided with sufficient reserves of power to prevent motor, sensor, or processor malfunctions that could lead to a fall that could potentially damage the robot and/or people and objects in the robot’s environment. Furthermore, the robot should be able to be recharged and return to work without requiring a human presence or distracting a human from other higher-level tasks that the robot may be freeing them to perform.

The disclosed docking station with wireless charging capabilities solves or improves upon the shortcomings of conventional (e.g., manual plug-in) charging systems. As such, the docking station is designed to be locatable by the robot, provide recharging power to the robot, and passively support the weight of the robot (e.g., allowing some or all of the robot’s power-consuming electrical and electromechanical systems to at least partly shut down during recharging, thereby reducing recharging time and preventing falls). One example docking station disclosed herein provides a support cradle configured to engage the robot proximal the robot’s waist, and wireless (e.g., inductive) charging pads in a base upon which the robot places its feet (e.g., which include inductive receiver coils). In general, the disclosed docking station allows the robot to walk up to the docking station, turn around, and walk backwards onto the base such that the support cradle at least partly surrounds the robot’s waist. The robot can then relax its knee actuators in a slightly “squatted” configuration to rest its torso upon the support cradle at the waist, while the robot’s feet rest upon the base to receive recharging power.

However, in some situations, it may not always be practical or possible to provide the robot with sufficient battery capacity and dedicated recharging opportunities to enable the robot to complete an assigned task or a full work shift. In such situations, the robot's operational endurance can be enhanced by providing the robot with supplemental power while it is actively performing its tasks. Previous solutions have implemented wired tethers to provide operational or supplemental power, for example, plug-in charging, but such tethers can impede the robot's movement, limit its operational envelope, and create tripping or entanglement hazards for both the robot and nearby human workers.

Disclosed herein is a wireless (e.g., inductive) charging system designed to efficiently recharge a battery pack housed within a humanoid robot within the robot’s operational environment, without a physical electrical conductor to interconnect the robot to a source of power. The battery pack serves as the primary energy source for the robot, enabling untethered mobility and the execution of various tasks without continuous reliance on an external power supply. Over time, as the robot performs its assigned operations, the battery naturally becomes un-charged due to energy consumption by its various subsystems. To sustain uninterrupted functionality, the disclosed wireless charging systems are designed to provide supplemental power to the robot at its work location, a concept referred to as opportunity charging. Such supplemental wireless power delivery within the robot’s operational environment can extend the amount of time that a robot can remain on task, and in some implementations, it can extend this time substantially and/or indefinitely by matching or exceeding the robot's average power consumption rate.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that the medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

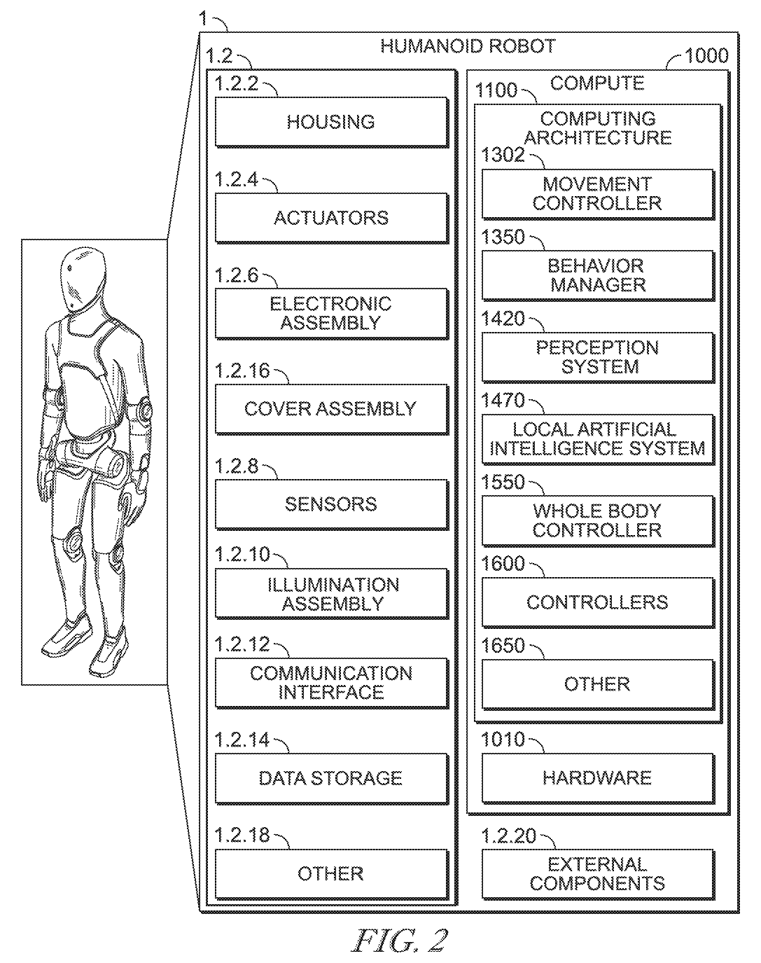

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 2.

Extended State: a state of the robot with the arms extended outward laterally at the shoulder and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) is a vertical plane positioned at a midway point between the left and right legs and the left and right arms and contains a rotational axis A₁₀ of a torso twist actuator (J10) located in the spine of the robot 1 and divides the left and right sides of the robot 1. In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, the axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment, the coronal plane (P_{C}) is a vertical plane that contains the rotational axes A₁₁ of the hip flex actuators (J11) located in the hips (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips of the robot 1.

Origin Point: an orthogonal intersection point of the sagittal plane, coronal plane, and transverse plane, all of which extend through the humanoid robot disclosed herein.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane, wherein the Z, Y, X reference axes intersect at the common origin point.

Kinematic Chain: a representation of an assembly of rigid bodies connected by joints to provide constrained motion. Within this application, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOTS AND ENVIRONMENT

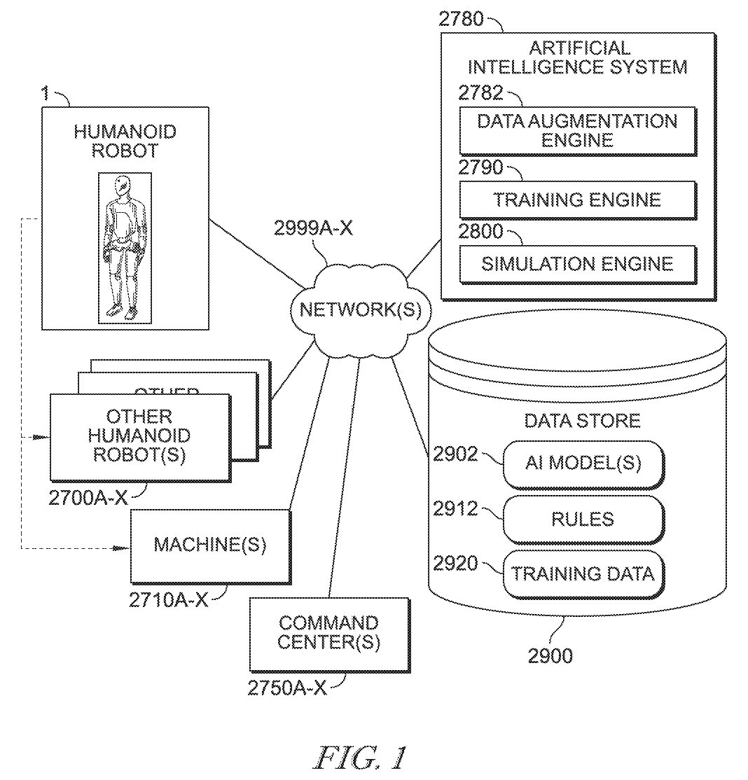

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may be the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated - e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, illumination assembly 1.2.10, communication interface 1.2.12, data storage 1.2.14, exterior covering assembly 1.2.16, other components 1.2.18, and (ii) compute 1000 that includes a computing architecture 1100 including instructions to be executed on computing hardware 1010 comprising at least one processor (e.g., CPU, GPU, MCU, etc.). The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650. The robot 1 is also configured to interface with external components 1.2.20, such as a charging system 3000.

### a. Humanoid Robot Configuration

The high-level configuration for the robot 1 includes assemblies that function together to provide the robot with a humanoid shape and enable the robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 may include the following systems, assemblies, components, and parts, which can be broadly categorized into three regions. These three regions include: (i) an upper portion, which includes a head and neck assembly, a torso 16, left and right arm assemblies, and left and right hands; (ii) a central portion, which includes a spine, a pelvis 64, left and right upper leg assemblies of left and right leg assemblies 6, and a waist 604; and (iii) a lower portion, which includes left and right lower leg assemblies of leg assemblies 6. Each lower leg assembly may comprise a shin, a talus, and a foot 92. In other embodiments, some of these systems, assemblies, components, or parts may be omitted, combined, or replaced with alternative designs.

### 1. Torso

The torso assembly 16 is a central component within the humanoid robot 1, extending vertically between the waist and the head and neck assembly, and horizontally between the shoulders. The torso 16 is designed to provide the robot 1 with a generally humanoid shape, offer structural and operable support for the arm assemblies and the head and neck assembly, and house and protect internal components, including the arm actuators (J1) and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a charging system, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 2. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin. Furthermore, the talus may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

A foot assembly is coupled to the leg assembly 6 and is configured to operatively couple the foot 92 to the talus and includes (i) a foot frame, (ii) a toe biasing device, and (iii) a receiver coil assembly 936. Further disclosure of the receiver coil assembly 936 and its components is provided below.

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

The electronics assembly 1.2.6 contained primarily within the torso 16 includes various interconnected components that are essential for the operation of the robot 1, including a battery pack 202, a power distribution unit, a charging system, and the compute 1000 (which includes CPUs and GPUs). The battery pack 202 and power distribution assembly are configured to provide power to various components, including actuators 1.2.4, positioned throughout the robot 1. For example, the battery pack 202 may be a rechargeable 1.5 kWh to 5 kWh battery pack, preferably between 2 kWh to 3 kWh. As such, the battery pack is configured to provide the robot with run times between 2.5 and 8 hours, preferably at least 3.5 hours during normal operating conditions. The power distribution unit is coupled to the battery pack 202 and includes the distribution connection as well as the battery charge/discharge circuitry of the charging system.

The charging system includes a wireless power receiver system 212.6 to facilitate wireless power transfer (WPT) via inductive charging. The charging system may include safety features such as overcharge protection and battery temperature monitoring. For example, the charging system may include charge monitor configured to monitor the battery health (e.g., battery state, charge level, battery temperature, power management, remaining operational time) and/or communicate with the charging system 3000 (also referred to as a “docking station” and/or “docking system”) and facilitate wireless power transfer (WPT).

### i. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. The humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Examples of communication interfaces 1.2.12 include a wireless communication interface (e.g., Bluetooth®, Wi-Fi®, WiMAX, Cellular (e.g., 3G, 4G, 5G), Zigbee, LoRa (Long Range) and RF (Radio Frequency)), a wired communication interface (e.g., Ethernet, USB, Serial Communication (e.g., RS-232, RS-485), and Controller Area Network (CAN) interface)), a local communication interface (e.g., an I2C (Inter-Integrated Circuit), SPI (Serial Peripheral Interface)), and a human-robot communication interface (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

### c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### E. CHARGING/DOCKING STATIONS

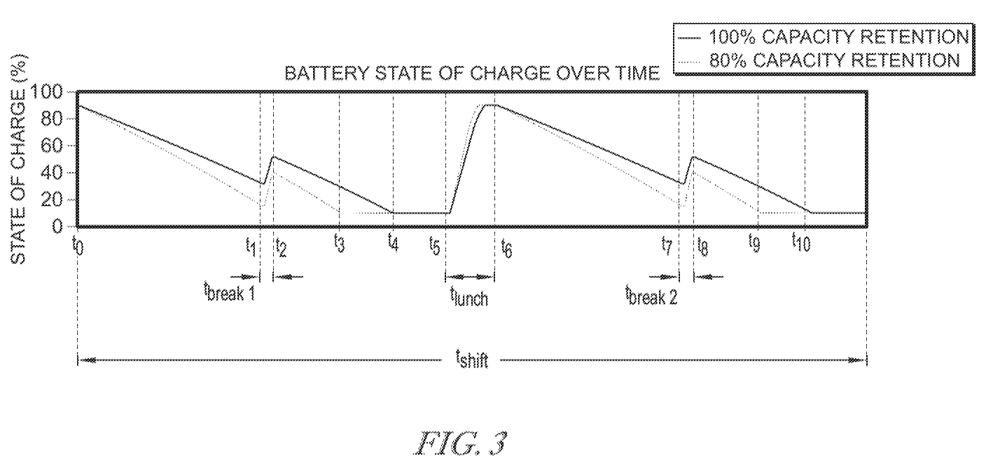

The robot 1 may be assigned tasks to perform in an operating environment during similar (e.g., the same) work shifts as a human worker. As such, the robot 1 may be limited to recharging the battery at specified times or intervals. FIG. 3 illustrates a graph showing one example of how the charge level of the battery contained in the humanoid robot may change over a work shift. The robot 1 may be performing tasks during the same work shift as a human worker, where the work shift has a predefined length of time (t_{shift}) and the human workers are provided with a lunch break (t_{lunch}) and two breaks (t_{break1}, t_{break2}) having predefined durations of time. However, depending on the power consumption of the robot 1, it may not have sufficient charge to continue working until the next break without recharging. For example, the two curves illustrate a range of battery capacity retention between 80% to 100%. The robot 1 may begin the work shift at an initial charge level and have enough power to work until the first break at t₁, however, the duration of the first break (t_{break1}) may only be long enough to partially recharge the battery. As such, the battery may be depleted to a low level between t₃ and t₄, which is prior to the lunch break (t_{lunch}) at t₅. Even though the robot 1 may be able to fully recharge during the lunch break (t_{lunch}), a similar issue may occur afterwards, where the duration of the second break (t_{break2}) may only be long enough to partially recharge the battery and the battery may be depleted to a low level between t₉ and t₁₀, which is prior to the end of the shift. Traffic issues may also arise within a workplace when multiple robots 1 have to re-charge and go back and forth to a work station and a location at which the robot 1 charges. The cumulative time spent traveling to and from a dedicated charging station may reduce the overall productive output of the robot 1 over the course of a shift. To address this situation, it may be desirable to provide convenient, wireless charging facilities for multiple robots within an operating environment.

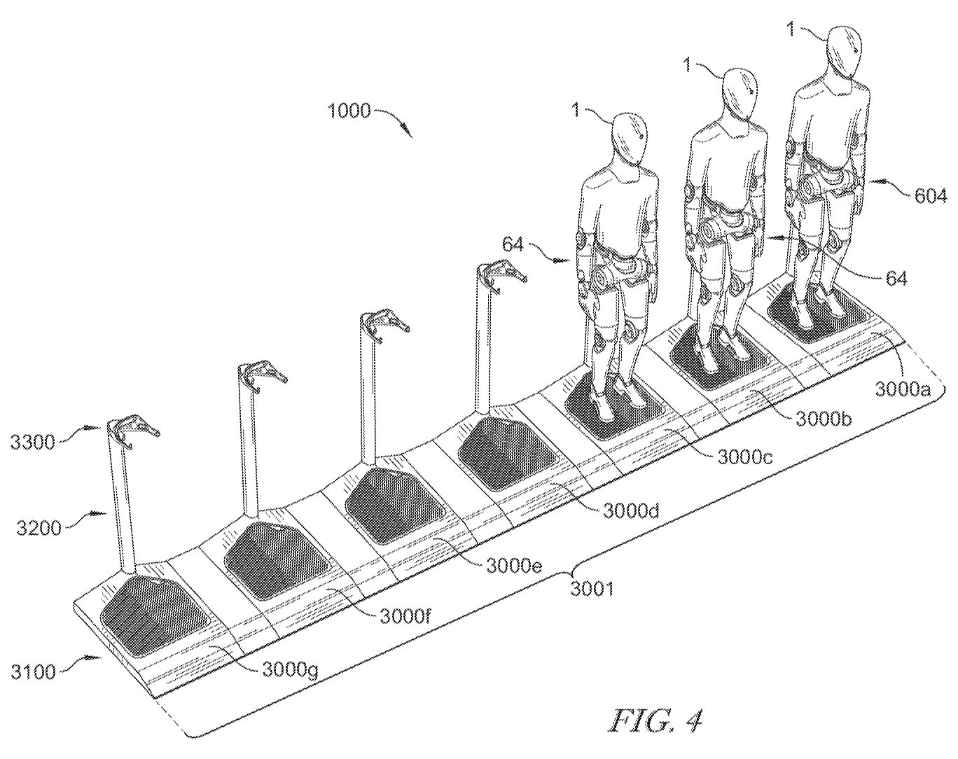

According to one or more embodiments, referring to FIG. 4, one way to provide convenient wireless charging for multiple robots within an operating environment is to provide charging systems 3000a-g in an array to form a charging bay 3001. The charging systems 3000a-g may be disposed in an array forming a charging bay 3001. However, the charging bay 3001 is not limited to the configuration of an array of the charging systems 3000a-g and may rather include the charging systems 3000a-g disposed in rows or in a circle. The charging bay 3001 may be deployed at a facility to facilitate concurrent charging of multiple robots 1. As illustrated in FIG. 4, each charging system 3000a-g may include a charging mat assembly 3100, a support frame assembly 3200, and a support cradle 3300, which is discussed in further detail below in addition to other charging systems according to one or more other embodiments. In some embodiments, the spacing between adjacent charging systems 3000a-g within the charging bay 3001 may be selected to allow the robots 1 to dock and undock without physical interference from neighboring robots 1 or charging systems 3000a-g.

### a. Wireless Power Receiver System

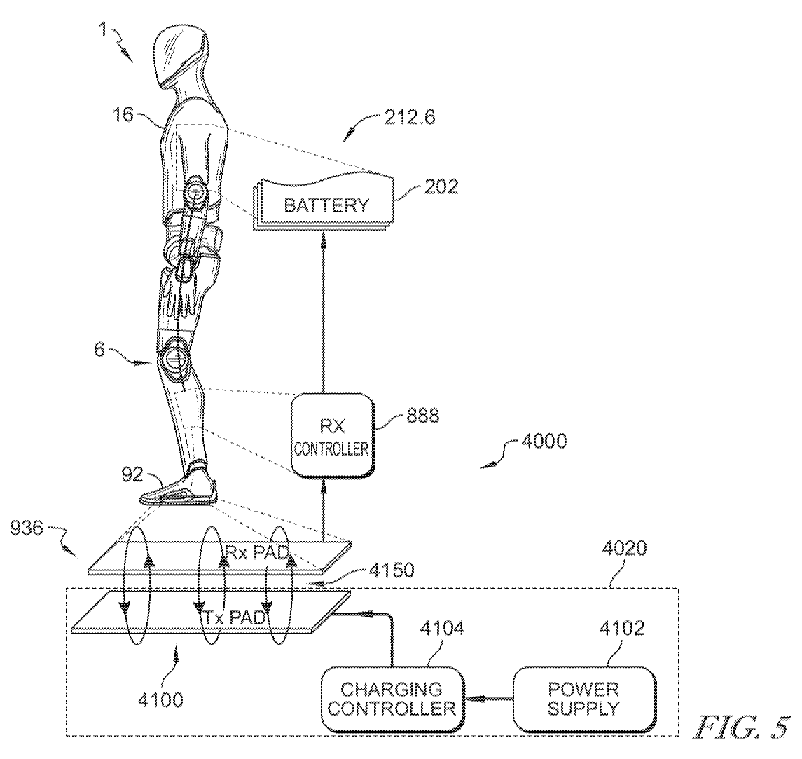

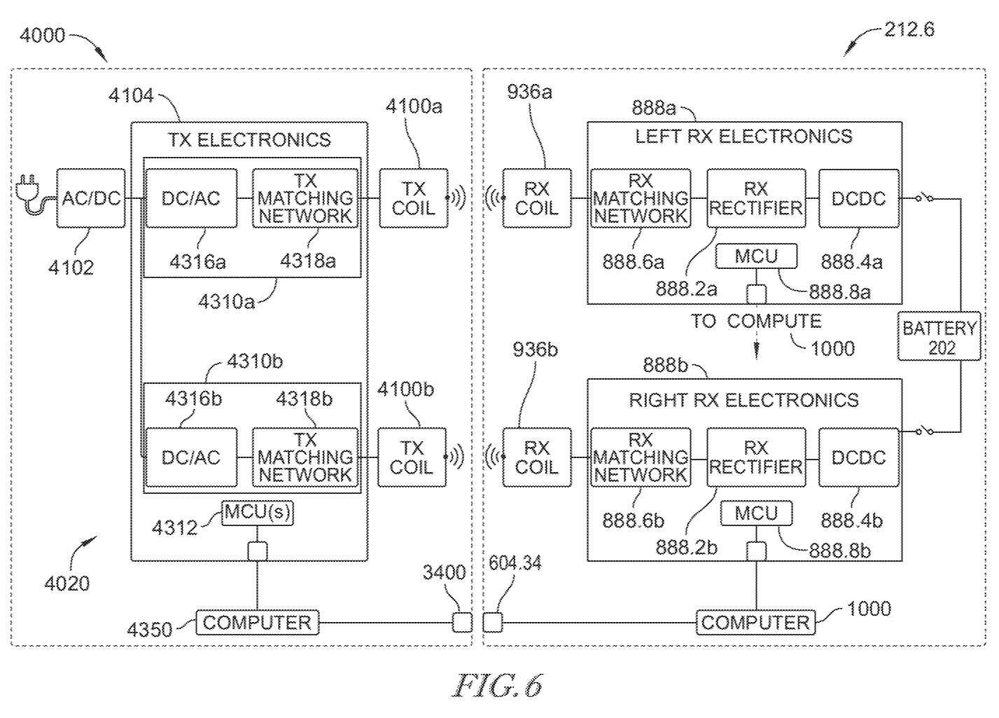

As illustrated in at least FIGS. 5 and 6, the wireless power receiver system 212.6 is configured to (i) deliver power to charge the battery pack 202 and (ii) communicate charging information to another device, such as a charging system 3000. The wireless power receiver system 212.6 includes a wireless power receiver electrically coupled to the battery pack 202 and communicatively coupled to compute 1000 and at least one communication interface 1.2.12. The wireless power receiver may include a receiver coil assembly 936 and a charging controller 888 in each leg 6. Both charging controllers 888a, 888b are further coupled to compute 1000, which may be further coupled to at least one communication interface 1.2.12. In the illustrative embodiment, the at least one communication interface 1.2.12 includes a communication transceiver 604.34 configured to connect with a communication transceiver 3400 housed within the charging system 3000. In alternative embodiments, the robot 1 and/or charging system 3000 may be configured with other means of communication, including but not limited to Bluetooth Low Energy (BLE), Zigbee, or near-field communication (NFC).

Including a receiver coil assembly 936 and a charging controller 888 in each leg 6 provides for faster charging and redundancy. For example, if a receiver coil assembly 936 is not functioning properly, the robot 1 may communicate a need for maintenance to an operator or a command center, while slowly charging the battery pack 202 using the other operational receiver coil assembly 936. This change in power distribution, monitoring, and communication may be monitored by the individual charging controller 888, the charge monitor, and/or other controllers 1600 contained in the robot 1. The dual-receiver architecture also allows the system to balance the thermal load across both legs 6, which may extend the operational lifespan of the receiver coil assemblies 936a, 936b and the associated electronics.

### i. Wireless Power Receiver

Referring to FIG. 5, the wireless power receiver includes the receiver coil assembly 936 (also referred to as a receiver coil, charging coil, foot charging coil, or charging coil assembly) and the charging controller 888 in each leg 6 that are electrically coupled with the battery pack 202. In the illustrative embodiment, the receiver coil assembly 936 in each foot 92 is electrically coupled to a charging controller 888 housed in the leg 6 (e.g., shin). Each receiver coil assembly 936 is configured to receive power by electromagnetic induction. The charging controllers 888a, 888b are configured to (i) deliver power to the battery pack 202 and (ii) communicate with the compute 1000 and communication transceiver 604.34.

### 1. Receiver Coil Assembly

In the illustrative example, the robot 1 includes receiver coil assemblies 936a, 936b arranged in each foot 92 and configured to create an alternating electric current when positioned within an oscillating magnetic field. In the example shown in FIG. 5, the robot 1 is configured to stand on a charging mat assembly 3100, so that the receiver coil assemblies 936a, 936b are substantially aligned with the transmitter coils 4100a, 4100b of the charging mat assembly 3100 to receive wireless power. With the receiver coil assembly 936 positioned within the oscillating magnetic field 4150 created by the wireless power transmitter device 4020 of the charging mat assembly 3100, the receiver coil assembly 936 receives an alternating electric current. The alternating electric current is transferred to the receiver charging controller 888 to convert the AC power into DC power that may be used to charge the battery pack 202 of the robot 1. For example, the robot battery may be charged from a predetermined low level (e.g., 5%-25%, preferably 10%) to a predetermined high level (e.g., between 75%-95%, preferably 80%) in a predetermined amount of time (e.g., less than 15 minutes, less than 30 minutes, less than 60 minutes, or any value between 5 minutes and 240 minutes). In various embodiments, this arrangement may add weight in the foot 92 and may require active cooling (e.g. a fan in the leg 6) to dissipate heat generated by the coil assembly. The rate of charging may be governed by a charging profile that is stored in the compute 1000 or in the charging controller 888, where the charging profile defines target voltage and current parameters as a function of the state of charge of the battery pack 202.

For example, each foot 92 of the robot 1 may be configured with a receiver coil assembly 936 enclosed by at least a sole of the foot 92. The receiver coil assembly 936 sized to be substantially similar to a main portion of the foot 92. The receiving coil assembly 936 includes a wire that may be wound to include a number of turns to form a planar coiled wire layer. For example, the wire may be Litz wire and the number of turns may be between 3 and 20, preferably between 5 and 10. The coiled wire layer may have a substantially oval or oblong shape dimensioned to be less than the perimeter of the foot base structure. In other embodiments, the coiled wire layer may have a rectangular, circular, or racetrack shape selected to maximize the coupling area within the available footprint of the foot 92.

The sole may be configured to contact the ground or support surface on which the robot 1 may walk and may be formed of a material that allows the magnetic field to interact with the receiver coil assembly 936 to transfer power. The receiver coil assembly 936 may include at least a receiving coil. The receiver coil assembly 936 may include a base or housing configured to hold the receiving coil, and shielding layers configured to shield against electromagnetic interference (EMI) and/or to insulate and resist heat buildup. For example, the shielding layers may include a nanocrystalline material. In various embodiments, a shoe cover may couple to or near the sole to further enclose the receiver coil assembly 936 and other components of the foot 92. The shoe cover may be made from a flame retardant material, such as a halogen-free flame retardant polymer or a self-extinguishing silicone compound.

In various embodiments, the charging assembly 936 may include a receiving coil module, a heat transfer device, a foot shield, and a toe shield. The coil module may include a receiving coil, a coil shield, and a module base. The heat transfer device is configured to be received in the foot base structure and coupled on the second side. The foot shield is positioned between the foot base structure and the receiving coil module. The foot shield is shaped to substantially cover the second side of the foot base structure including the heat transfer device. A toe shield may be coupled to the lower surface of the toe structure. The foot shield, toe shield, and coil shield may each be configured to reduce electromagnetic interference, and the combination of these shields may provide a layered attenuation effect that reduces stray field emissions to levels compliant with applicable regulatory standards.

The receiving coil includes a wire that may be wound to include a number of turns to form a planar coiled wire , a first end lead, and a second end lead. For example, the wire may be Litz wire and the number of turns may be between 3 and 20, preferably between 5 and 10. The coiled wire may have a substantially oval or oblong shape dimensioned to be less than the perimeter of the foot base structure of the foot frame. The first end lead may extend from an interior portion of the coiled wire and the second end lead may extend from an exterior portion of the coiled wire . The first and second end leads may include insulation sleeves to reduce electromagnetic interference and to provide mechanical strain relief at the transition between the coiled wire and the lead conductors.

The coil shield has a substantially oval or oblong shape configured to overlay the shape of the receiving coil. The coil shield is substantially planar and may include one or more layers of shielding material. The coil shield may include a first layer configured to shield against electromagnetic interference (EMI) and a second layer configured to insulate and resist heat buildup, where the second layer may be positioned between the first layer and the receiving coil. For example, the first layer may be a nanocrystalline material and the second layer may include a polyimide film, such as Kapton® or other high-performance film. The coil shield includes a shield layer and an edge notch configured to allow passage of the first and second end leads of the receiving coil through the coil shield. The shield layer is configured to receive the first end lead therethrough. The edge notch is positioned to receive the second end lead therethrough. In some embodiments, the coil shield may further include a slit or narrow gap opening that extends between the shield layer and the edge notch configured to reduce the eddy current losses induced by the first end lead. The coil shield may be adhered to the planar coiled wire with the first and second end leads extending through the shield layer and an edge notch, respectively.

The module base has a shape substantially similar to the foot base structure. For example, the module base is dimensioned to have a perimeter that is substantially the same as, or less than, the perimeter of the foot base structure, such that the charging module may be coupled to the foot base structure and be received within the main interface surface of the sole. The module base includes a first side configured to face the foot base structure and a second side configured to couple with the sole. The module base may have a thickness (t_{CM}) between the first side and the second side that is greater than the thickness (t_{WL}) of the planar coiled wire . A coil receptacle is formed in the first side of the module base and shaped to receive the coiled wire of the receiving coil, with the second end lead positioned toward the front end of the module base. The coil receptacle may include an oblong recess dimensioned to substantially match the depth, general shape, and total width based on the number of turns of the planar coiled wire . The coil receptacle also includes an interior portion having the same thickness (t_{CM}) as the module base, where the coiled wire is received into the oblong recess surrounding the interior portion. The coil shield substantially encloses the coiled wire within the module base. The module base may be formed of a thermoplastic material. For example, the module base may include a polybutylene terephthalate (PBT) and fiberglass (FG) substrate and an ethylene vinyl acetate (EVA) surface material. In alternative embodiments, the module base may be formed from a polyamide (nylon) or a polyphenylene sulfide (PPS) composite, each of which may provide enhanced dimensional stability at elevated temperatures.

The foot shield is configured to substantially cover the second side of the foot base structure, including at least a portion of joint coupling portions. Similar to the coil shield, it may include one or more shielding layers. For example, a first foot shield layer may be configured to shield against electromagnetic interference (EMI) and a second foot shield layer may be configured to insulate or protect the first layer. The first foot shield layer may be a nanocrystalline material and the second layer may include polymer or plastic, such as polyethylene terephthalate (PET). Further, the foot shield includes first and second shield openings configured to allow passage of the first and second end leads of the receiving coil. Similarly, the toe shield may comprise the same layers as the foot shield and be coupled to the lower surface of the toe structure.

The heat transfer device is configured to be received into the compartment formed in the second side of the foot base structure. The heat transfer device includes a base plate and heat transfer units coupled to the base plate. The base plate has a first side and a second side and is dimensioned to fit and substantially cover the compartment on the second side of the foot base frame. The base plate includes first and second plate openings configured to allow passage of the first and second end leads of the receiving coil into the foot base structure. The base plate includes first and second plate openings that are centered, and the heat transfer units are coupled to the first side of the base plate on left and right sides of the first and second plate openings. The first plate opening is set back from the front edge of the base plate and the second plate opening is formed as a notch in the rear edge of the base plate. In some embodiments, the second plate opening is expanded to include the first plate opening as an elongated slot, which may simplify the routing of the end leads and facilitate assembly.

The heat transfer device is received into the compartment formed in the second side of the foot base structure and secured thereto. The heat transfer units are spaced apart and configured to be received on the left and right sides of the pair of central supports that span the length of the forward platform section, where the first and second plate openings align with the wiring channel formed between the pair of central supports such that the first and second end leads of the coil module may be routed to the wiring channel of the rear platform portion and to other parts of the robot 1. In particular, the first and second end leads extend through the coil shield and foot shield before passing through the first and second plate openings. The heat transfer units may be configured as finned heat sinks, pin-fin arrays, or flat-plate conductors, depending on the available volume within the compartment and the anticipated thermal load.

### 2. Charging Controllers

The charging controllers 888a, 888b are electrically coupled to respective receiver coil assemblies 936a, 936b in each foot 92. The charging controllers 888a, 888b each include receiver electronics configured to convert the alternating current (AC) induced in the receiver coil assembly 936 by the magnetic field to direct current (DC) to charge the battery pack 202 of the robot 1. Each of the right and left receiver charging controllers 888a, 888b may include (i) a receiver rectifier 888.2a, 888.2b, (ii) a DC to DC converter 888.4a, 888.4b, (iii) a receiver matching network 888.6a, 888.6b, and (iv) a microcontroller unit 888.8a, 888.8b, as shown in FIG. 6. For example, the matching network 888.6a, 888.6b, the rectifier 888.2a, 888.2b, and the DC/DC converter 888.4a, 888.4b may be configured to regulate voltage or current to appropriate levels for the robot's power loads, and a controller 888.8a, 888.8b may be configured to manage power flow. In certain embodiments, the rectifier 888.2a, 888.2b may be realized as a diode full-bridge rectifier or an active synchronous rectifier. This rectified DC voltage may then be supplied to the DC/DC converter 888.4a, 888.4b. In the illustrative embodiment, the DC converter 888.4a, 888.4b is coupled to the battery pack 202 to provide power to charge the battery pack 202 arranged in the robot's torso 16. In certain embodiments, a single charging controller 888 may include one set of receiver electronics for both the receiver coil assemblies 936a, 936b. In some embodiments, the DC/DC converter 888.4a, 888.4b may be a buck converter, a boost converter, or a buck-boost converter selected to accommodate the range of voltages expected at the output of the rectifier 888.2a, 888.2b over varying coupling conditions.

Additionally, the microcontroller unit 888.8a, 888.8b of each charging controller 888a, 888b is further connected to compute 1000 and configured to deliver information regarding the status and/or operation of the receiver coil assembly 936 in foot 92. The individual microcontroller units 888.8a, 888.8b may be configured to collect and communicate information regarding the operation of the wireless power receiver, including voltage and/or current received by respective receiver coil assemblies 936a, 936b while charging, temperature and/or other sensor readings, and fault information. The microcontroller units 888.8a, 888.8b may also be configured to execute local protection algorithms, such as overvoltage protection, overcurrent protection, and over-temperature shutdown, independent of the compute 1000, to provide a fast-acting safety response.

### ii. Data Communication

The wireless power receiver system 212.6 is configured to communicatively couple the wireless power receiver to compute 1000 and at least one communication interface 1.2.12 of the robot 1 to establish a data connection with charging system 3000. When communication is established, the robot 1 and charging system 3000 may communicate information, including: (i) when the robot 1 is at or on the charging mat assembly 3100, (ii) when the robot 1 needs to reposition itself on the charging mat assembly 3100 and/or charging system 3000, (iii) when to begin charging, (iv) how fast to charge, (v) how much power to supply to the battery or how much to charge the battery, and (vi) when charging of the battery pack 202 is complete. The data connection may also be used to communicate diagnostic information, firmware version identifiers, and robot identification credentials to the charging system 3000.

### 1. Communication Transceiver

In the illustrative embodiment, the at least one communication interface 1.2.12 includes a communication transceiver 604.34 coupled within the waist 604 of the robot 1 in a rear position. This arrangement of the communication transceiver 604.34 provides an accessible location to establish a wireless bridge with a similar communication transceiver. In the illustrative embodiment, the charging system 3000 includes communication transceiver 3400 positioned in the support cradle 3300, where the communication transceiver 3400 is substantially identical to communication transceiver 604.34 in the robot 1. This design symmetry is advantageous for the purposes of manufacturing, inventory management, and system testing. For example, the communication transceiver 604.34 and the communication transceiver 3400 can be configured to operate in accordance with established industry standards such as IEEE 802.11ad and 802.11ay (also known as WiGig), functioning within the unlicensed 60 GHz V-band spectrum. The selection of the 60 GHz band, or other similar millimeter-wave frequency segments, allows for multi-gigabit data throughput. It should be understood that in other embodiments, the communication transceivers 604.34, 3400 may not operate in the millimeter-wave band in accordance with an IEEE standard, but instead may operate in any known frequency (including the frequencies disclosed herein) and may use or operate in accordance with any known communications standard (including the standards disclosed herein).

Moreover, a data communication link may be established when the communication transceiver 604.34 of the robot 1 is in close proximity of the communication transceiver 3400. The data communication link allows the robot 1 and charging system 3000 to exchange information to facilitate docking and charging of the robot 1. Once the data communication link is established, the robot 1 and the charging system 3000 may communicate: (i) location information, (ii) foot position information, (iii) charge initiation information, (iv) charge level information, (v) charging speed information, (vi) any other information that would be helpful in charging the robot 1, (vii) any information that would be obvious to one of skill in the art based on this disclosure, and/or (viii) any combination thereof. Once the robot 1 is in a fully docked position, the robot 1 may be configured to download data to a station computing device 4350 of the charging system 3000 while it is charging its battery pack 202. The data communication link may employ error-correction coding and packet acknowledgment protocols to ensure data integrity during transfer.

### 2. Docked Transceiver Alignment

The robot 1 includes communication transceiver 604.34 coupled within its waist 604. The outer covering of the waist 604 provides adequate protection for the internally mounted antenna array without imposing a substantially negative effect on the RF transmissions. When the robot 1 is nearly or fully docked, the communication transceiver 604.34 is positioned such that it substantially aligns with the position of the communication transceiver 3400 located in the support cradle 3300 of the charging system 3000, so the transceivers are substantially parallel and separated by a minimal air gap (e.g., less than 36 inches, preferably less than 6 inches, and most preferably less than 2 inches). The outer covering of the waist 604 may be formed from a material having a low dielectric loss tangent at the operating frequency of the communication transceivers 604.34, 3400, such that signal attenuation through the covering is minimized.

The robot 1 includes concave recesses formed in the body of the waist 604 designed to engage with a support structure. When the robot 1 is fully docked with charging system 3000, the robot 1 is also supported by the support cradle 3300. The robot 1 can be supported at each side at the waist 604. This physical engagement provides definitive tactile feedback to the internal sensors 1.2.8 of the robot 1 and ensures a highly repeatable final docked position. This high degree of precision is useful for the purpose of optimizing the coupling efficiency for wireless power transfer, as even minor misalignments in the positioning of the coils can degrade the overall rate of charging.

The robot 1 may be configured to use force and torque sensors that are located in its spine and hip to position itself on a support structure. For example, in the illustrative embodiment, as the robot 1 lowers itself onto the cradle 3300 of the charging system 3000, it may utilize the force and torque sensors, other internal sensors 1.2.8, and optionally also make contact with the support cradle 3300 itself, to attain simultaneous, balanced contact with both of the cradle arms 3302a, 3302b and the rear support pad 3312. An unevenly distributed pressure reading would signal a misalignment, prompting the robot 1 (e.g., using behavior manager 1350, whole body controller, other controllers 1600) to make micro-adjustments. A definitive tactile cue may be the distinct haptic feedback that is generated as the vertical alignment posts 3306a, 3306b fully seat themselves into their corresponding recesses on the robot 1. This provides an unambiguous, non-visual confirmation that the robot 1 is nominally positioned and that the docking maneuver has been completed.

### iii. Charge Monitor

The charge monitor is configured to execute on compute 1000 to monitor the state of the battery pack 202 and communicate status information to other devices, as needed, to assist in the charging of the battery pack 202. The charge monitor is configured to interface with sensors 1.2.8, the battery pack 202, power distribution system, and/or the charging system to monitor status of the battery pack 202, including but not limited to charge state, charge level, received voltage, battery temperature, power management, remaining operational time, as well as other sensor measurements. Additionally, the charge monitor may be configured to communicate battery status information to external components 1.2.20 for various reasons. For example, the charge monitor may communicate information to a charging system 3000 to facilitate wireless power transfer (WPT). The charge monitor may also maintain a log of historical charge and discharge cycles, which may be transmitted to a fleet management system or cloud-based AI system for predictive battery health analysis.

To address the issue of insufficient battery life during a task , the robot 1 may change the timing, duration, or frequency of its breaks to ensure that it can perform tasks for the entire shift without an extended work stoppage. Referring back to the example shown in FIG. 3, the robot 1 may change the duration of one or more breaks to ensure that there is enough power to perform the task. In another example, the charge monitor may detect a low power level of the battery pack 202 while the robot 1 is performing a task. In response to the detected low power level, the robot 1 may complete or safely interrupt the task, then relocate to a power source for charging. However, in some examples, it may not be possible to modify the timing, duration, or frequency of breaks; thus, it may be possible to charge while continuing to perform the task. In some examples, the robot 1 may wirelessly charge via its feet 92 while standing to perform a task. Additional disclosure about wirelessly charging during the performance of a task is discussed in connection with U.S. Provisional Application 63/874,723, which is hereby incorporated by reference.

Additionally, the charge monitor may communicate information regarding the battery and/or wireless power receiver system 212.6 to a charging system 3000 to facilitate wireless power transfer (WPT). The charge monitor may receive information from the charging controllers 888a, 888b regarding the respective receiver coil assemblies 936a, 936b in each foot 92. The information regarding receiver coil assemblies 936a, 936b may include received voltage, temperature, fault detection, and operational status to communicate to the charging system 3000 to affect real-time adjustments of strength of the transmitted power. Communication between the charging system 3000 may further provide information for adjustment of the foot 92. In some embodiments, the charge monitor may implement a state machine that transitions between states such as idle, pre-charge, constant-current charging, constant-voltage charging, trickle charging, and fault, with each state having defined entry and exit conditions.

### b. Charging Systems

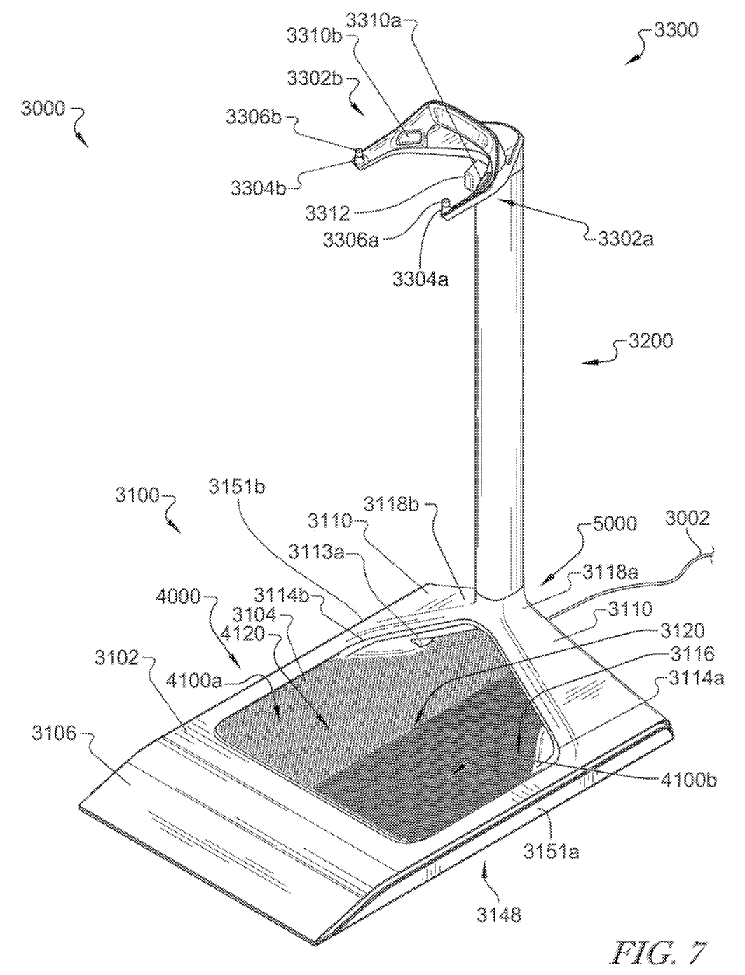

FIG. 7 illustrates one example of a charging system 3000, which may be similar to the charging systems 3000a-g shown in FIG. 4, that includes: (i) a charging mat assembly 3100, (ii) a support frame assembly 3200 (also referred to as a support stand), (iii) a wireless power transfer (WPT) system 4000, (iv) a station electronics assembly, and (v) an active cooling system 5000. The charging mat assembly 3100 includes a base housing and a wireless power transmitter device 4020 (also referred to as wireless power transmitter, transmitter device, or wireless power transfer (WPT) device). The support frame assembly 3200 is coupled to the charging mat assembly 3100 and includes a flared base 3110, a vertical support portion, and a support cradle 3300, where the support cradle 3300 is positioned above the charging mat assembly 3100 and configured to mechanically couple with the robot 1. The station electronics assembly includes a sensor assembly, a communication transceiver 3400, and a station computing device 4350. The WPT system 4000 includes the wireless power transmitter device 4020 in the charging mat assembly 3100 configured to transfer power to the robot 1, the station computing device 4350, and a communication transceiver 3400 configured to form a data communication link with the robot 1. The active cooling assembly 5000 is configured to facilitate the removal of thermal energy generated by wireless power transmitter device 4020 in the charging mat assembly 3100.

The WPT system 4000 includes the wireless power transmitter device 4020 in the charging mat assembly 3100 configured to transfer power to the robot 1, where the robot 1 is configured to receive power by induction. In the illustrative embodiment, the robot 1 includes a wireless power receiver system 212.6, wherein left foot and the right foot each include a receiver coil assembly 936a, 936b. The WPT system 4000 also includes the station computing device 4350 coupled to the sensor assembly and the communication transceiver 3400. The station computing device 4350 is configured to establish a data communication link with the robot 1 via the communication transceiver 3400 to facilitate positioning of the robot 1 for charging. The computing device 4350 may also communicate information from the sensor assembly to facilitate positioning of the robot 1.

As illustrated in FIGS. 4 and 7, the robot 1 is configured to position its feet 92 on the charging mat assembly 3100 of the charging system 3000 at a wireless charging region 4120 and be supported at its waist 604 from the rear by the support cradle 3300. This rear engagement between the charging system 3000 and the robot 1 represents a significant departure from the design of conventional chargers. In particular, conventional chargers that facilitate a forward engagement between a robot and a charger may be sufficient for mechanically stable wheeled platforms. However, these conventional chargers are inadequate for humanoid embodiments that pose a higher center of gravity, feature sensors, manipulators, and communication arrays on their anterior side, and need to occupy a minimal floor-based footprint while allowing for autonomous docking maneuvers. This rear-support configuration also unconventionally leaves the forward-facing operational systems of the robot 1 entirely unobstructed, permitting the robot to continue monitoring its environment, processing data, and/or communicating while securely docked. Other benefits of utilizing a rearward supporting design may be obvious to one of ordinary skill in the art based on the present disclosure and the accompanying figures.

### i. Charging Mat Assembly

The charging mat assembly 3100 includes a wireless power transmitter device 4020 configured to inductively couple with the robot 1 for charging of its battery pack, a thermal transfer device configured to help dissipate thermal energy generated by the wireless power transmitter device 4020 during charging, and a base housing configured to substantially enclose the wireless power transmitter device 4020 and at least a portion of the thermal transfer device. The charging mat assembly 3100 features a low-profile design (e.g., with an upper surface that is less than 8 inches, preferably less than 5 inches, and most preferably less than 2 inches above a support surface) and is dimensioned to facilitate positioning of the robot 1 to couple with the charging system 3000, including spacing and placement of the robot's feet 92. The low-profile design reduces the height differential that the robot 1 must traverse during a docking maneuver, which in turn reduces the mechanical demands on the robot's locomotion controllers and actuators.

### ii. Base Housing

The base housing includes a base frame, a base layer 3148 coupled to a bottom surface of the base frame to form a compartment, and an upper platform coupled to an upper surface of the base frame that substantially encloses the compartment. The base frame is dimensioned to substantially contain the wireless power transmitter device 4020 within the compartment and to couple with the support frame assembly 3200. The base housing is also configured with a gentle ramp configured to make the overall docking process more robust by reducing the likelihood of a trip or a stumble, while also allowing the charging system 3000 to meet various safety and accessibility standards. The base housing may further include internal ribs or gussets that increase the structural rigidity of the compartment without adding substantial weight.

The base frame includes a front ramp portion, a main support portion, and a rear interface portion. At least the main support portion and the rear interface portion may have a substantially C-shaped profile (in other embodiments, the profile may be U-shaped, V-shaped, or any other conventional shape) providing an internal shelf configured to receive and couple to the wireless power transmitter device 4020, a bottom surface configured to receive a base layer 3148 configured to be in contact with the floor or support surface, and a top surface configured to receive the upper platform. The left and right sides 3151a, 3151b are substantially similar with mirrored features that include a gentle incline defining the front ramp portion configured to minimize the required lift height of a foot 92 of the robot 1 during docking. The rear portion is configured to couple with the support frame assembly 3200. The base layer 3148 couples to the bottom of the base frame. This base layer 3148 provides a high-friction surface configured to inhibit the charging system 3000 from sliding on the floor and also can protect the floor surface from scratches. For example, the base layer 3148 may comprise a rubber sheet, a thermoplastic elastomer (TPE), or any other similar material. Additionally/alternatively, the base layer 3148 may also include shielding layers to prevent EMI noise from radiating downward from the system. In some embodiments, the base layer 3148 may further include a vibration-dampening sublayer configured to reduce the transmission of mechanical vibrations between the charging system 3000 and the floor or support surface.

The upper platform provides a durable, protective covering for the internal components, engineered to withstand the static and dynamic loads exerted by the robot 1 during docking, charging, and undocking maneuvers. The upper platform can be composed of two different layers, wherein a first lower layer is designed as a support layer and the second upper layer is designed as a robot interface layer. For example, the first, lower layer may be made from a thicker (in comparison to the upper layer), durable material, and the second, upper layer is made from a thinner (in comparison to the lower layer), high-friction material. Specifically, the lower layer can be made from plastic, and the upper layer can be made from PPE foam or another flame-resistant compound. The upper platform includes a substantially flat base platform portion 3102 and a beveled front edge portion 3106 that is shaped to couple with the front ramp portion. The ramped or angled portion 3106 extends rearward from a frontal extent of the docking station and terminates at the start of the flat base platform portion 3102. The ramped or angled portion 3106 is coupled to the front ramp portion of the base frame and is not textured. The flat base platform portion 3102 of the upper platform may include a wireless charging surface 3104 in the wireless charging region 4120 upon which the robot 1 can arrange its feet 92 for wireless charging. This wireless charging surface 3104 may be textured with a high-friction material or may include clear visual markings to provide a distinct target for the foot 92 placement of the robot 1, aiding its visual servoing system during final alignment.

The flat base platform portion 3102 that extends rearward of the ramped or angled portion 3106 and is designed to overlay a major portion of the wireless power transmitter device 4020. As such, the flat base platform portion 3102 of the upper platform may include a wireless charging surface 3104. In other words, the wireless charging surface 3104 may occupy less than the entire flat base platform portion 3102 and preferably occupies more than a majority of the flat base platform portion 3102. The flat base platform portion 3102, and more specifically the wireless charging surface 3104 is designed to support and underly the feet 92 of the robot 1 for wireless charging. This wireless charging surface 3104 may be textured with a high-friction material and/or may include clear visual markings to provide a distinct target for the foot 92 placement of the robot 1. In the illustrative embodiments, the wireless charging surface 3104 may include projections and recesses 3116 to provide the textured surface. In other embodiments, the wireless charging surface 3104 may not be textured (e.g., substantially smooth), may be transparent to show the internal electronics, may not include visual markings, and/or may include other indicia that are intended to communicate the brand, serial number, manufacture date, and/or any other information. In some embodiments, the wireless charging surface 3104 may include embedded LEDs or electroluminescent strips configured to illuminate when the charging system 3000 is powered on or when charging is active, thereby providing a visual indicator of the system status to nearby operators and robots 1.

### iii. Wireless Power Transmitter

The wireless power transmitter device 4020 includes: (i) two transmitter coil assemblies 4100a, 4100b, (ii) a power supply unit 4102, and (iii) a charging controller 4104. In the illustrative embodiment, the two coil assemblies 4100a, 4100b, two transmitter power electronics, a transmitter controller 4312, and the power supply unit 4102 are shown positioned to be coupled to the base support plate, which is a rigid substrate configured to support components of the wireless power transmitter device 4020. In other embodiments, the power supply unit 4102 and/or the charging controller 4104 may be housed separately, for example, in the support frame assembly 3200 or an external enclosure, and electrically coupled to the coil assemblies 4100a and 4100b arranged in the charging mat assembly 3100. The charging controller 4104 includes left and right transmitter power electronics coupled to respective coil assemblies 4100a, 4100b and a transmitter controller 4312, for example, a microcontroller unit (MCU). In various embodiments, the transmitter controller 4312 may also be coupled to or integrated with a computing device 4350. The wireless power transmitter device 4020 is received within the base housing, where the base support plate is coupled to the base frame.

The wireless power transmitter device 4020 includes a pair of transmitter coil assemblies 4100a and 4100b, which are positioned adjacent to or near a bottom surface of the flat base platform portion 3102 of the upper platform. As such, the top surface of the transmitter coil assemblies 4100a and 4100b is within 50 mm, preferably within 25 mm, and most preferably within 5 mm of the bottom surface of the flat base platform portion 3102 of the upper platform. This arrangement causes the pair of transmitter coil assemblies 4100a and 4100b to be positioned directly beneath the wireless charging surface 3104 in the wireless charging region 4120. In addition to being positioned beneath and adjacent/near the bottom surface of the flat base platform portion 3102 of the upper platform, the transmitter coil assemblies 4100a and 4100b are arranged in a side-by-side configuration that corresponds to the neutral stance of the left and right feet 92 of the humanoid robot 1. This arrangement places the center of the coil assemblies within 400 mm, preferably within 300 mm, and most preferably within 250 mm of each other, while providing at least a gap of at least 100 mm and preferably more than 150 mm between the centers of the coil assemblies. The side-by-side configuration may also reduce mutual coupling between the two transmitter coil assemblies 4100a, 4100b, which could otherwise introduce efficiency losses or unwanted cross-talk between the two independent charging channels.

In the illustrative embodiment, the two coil assemblies 4100a, 4100b, the transmitter power electronics, the transmitter controller 4312, and the power supply unit 4102 are shown positioned to be coupled to the base support plate, which is a rigid substrate configured to support components of the wireless power transmitter device 4020. In other embodiments, the power supply unit 4102 and/or the charging controller 4104 may not be coupled to base support plate. Instead, the components may be housed in a separate structure that is distinct and physically separated from the charging system 3000. While the separate housing may be physically separated from the charging system 3000, it should be understood that the electronics contained within the housing are electrically coupled to the coil assemblies 4100a and 4100b arranged in the charging mat assembly 3100.

### 1. Coil Assemblies

The transmitter coil assemblies 4100a and 4100b are positioned adjacent to or directly beneath the wireless charging surface 3104 in a side-by-side configuration that corresponds to the neutral stance of the left and right feet 92 of the humanoid robot 1. The wireless power transmitter device 4020 includes two transmitter coil assemblies 4100a, 4100b, each coupled to the charging controller 4104. Each coil assembly 4100 may include a coil module, a magnetic shield, a support plate, a heat spreader, and a thermal interface material (TIM) layer. Each coil module includes a coil arranged within a carrier and covered by a protective cap. In some embodiments, the TIM layer can be made of silicone-based thermal pads, graphite pads, phase change materials, silicone-based thermal greases, non-silicone thermal greases, metal-based thermal pastes, thermally conductive gels, epoxy adhesives, silicone adhesives, acrylic adhesives, and thermally conductive tapes. It should be understood that in other embodiments, the transmitter coil assemblies 4100a and 4100b may include fewer, additional, or different layers arranged to facilitate power transfer and thermal management. This layered design facilitates the efficient transfer of heat away from the current-carrying coils.

The transmitter coil modules each include a collection of windings arranged as a coil having a predetermined pattern on a substrate or carrier. In this embodiment, the coil is shown as a planar, racetrack-shaped, or ovular coil, which is a geometry that can be engineered to create an elongated and uniform charging area. The windings themselves are formed from an electrical conductor or wire. In some embodiments, the wire may be Litz wire, which is made up of many fine, individually insulated strands that are woven or twisted together in a specific pattern. This construction is chosen to mitigate the detrimental effects of AC resistance at high frequencies, namely the skin effect, where current tends to flow only on the conductor's surface, and the proximity effect, where currents in adjacent conductors interact and further constrict the current flow. By using Litz wire, these AC losses are reduced, which can increase the quality factor (Q-factor) of the coil and, consequently, its overall energy transfer efficiency.

The geometry of the coil can be selected and sized to accommodate the shape of the robot's foot 92 and/or the receiver coil assembly 936 that is arranged within the foot 92, and to provide a significant degree of tolerance to minor misalignments in position and orientation. As such, the coil may be configured in a variety of shapes, including square, triangular, curvilinear (e.g., circular, oval, or elliptical), three-dimensional (e.g., helical or solenoidal coil), irregular, or amorphous, to optimize performance. Further, instead of being a winding of wire, the coil may be replaced with a solid bar, a flat planar piece of metal, printed circuit board (PCB) traces, conductive inks, polymers, or pastes printed onto a substrate, or any other known material configuration suitable for generating a magnetic field. In other embodiments, the transmitter coil assembly 4100 may also be part of a more complex array of coils. For instance, in some embodiments, the wireless charging surface 3104 may house multiple, concentric, or overlapping coils that are designed to create an even larger and more uniform effective charging area. Such advanced configurations may be selected to further enhance the robustness of the autonomous docking process by making the final placement of the robot's feet 92 even less precise. Further, the coils may be arranged in a phased array, could be actuated to allow for their physical repositioning to achieve optimal alignment, and/or may contain more than two coils that are arranged in a honeycomb or hexagonal pattern to create a contiguous charging surface.

The transmitter coil assembly 4100 may further include a shield layer (e.g., a ferrite sheet), which functions as a magnetic shield. The shield layer is typically disposed on or integrated with the carrier, on the side that is opposite the coil windings. The primary function of the shield layer is to effectively manage the magnetic flux generated by the coil. Ferrite materials, such as Manganese-Zinc (Mn-Zn) ferrite (e.g., TDK PC95 or DMR95), may be used for this purpose due to their high magnetic permeability and low core loss characteristics at the system's intended operating frequency (e.g., a frequency between 20 and 200 kHz, and preferably between 70 and 100 kHz). In other embodiments, the shield layer may include or be made from nickel-Zinc (Ni-Zn) ferrite, amorphous magnetic materials, nanocrystalline materials, aluminum, copper, and/or magnetic composites. Furthermore, the shield layer may partially surround the coil, and/or the system may include a secondary, actively driven coil that generates a magnetic field to cancel out stray flux.

The high magnetic permeability of the shield layer provides a low-reluctance path for the magnetic field lines. This has the effect of guiding and concentrating the magnetic flux, directing it efficiently upwards toward the intended receiver coil assembly 936 on the robot 1, while simultaneously reducing its undesirable radiation downwards into the base of the charging mat assembly 3100. This flux guidance can improve the magnetic coupling between the transmitter and receiver coils, which can in turn enhance the overall power transfer efficiency of the system. Concurrently, the shield layer serves to shield the underlying components of the charging system, such as sensitive power and control electronics, from the strong, oscillating magnetic field. This shielding reduces the induction of eddy currents in underlying conductive structures, which would otherwise result in parasitic power losses, excessive heating, and the potential for electromagnetic interference (EMI) with the control circuitry. This also helps the system meet regulatory standards for electromagnetic emissions, such as FCC Part 15 and CISPR 25, the latest versions of both of which are incorporated herein by reference. In some embodiments, the shield layer may not be a single monolithic piece but can instead be constructed from a collection of individual ferrite bars or strips that are arranged in a parallel array. This segmented construction allows for a degree of flexibility and can help to mitigate the risk of fracture in the otherwise brittle ferrite material.

In some embodiments, the transmitter coil assembly 4100 may be implemented as a "balanced coil," such as a bipolar coil that includes two identical circuits wound in a reverse orientation relative to each other. In such a configuration, when no foreign object is present, the magnetic fields generated by the two circuits will substantially cancel each other out, resulting in a substantially net-zero induced voltage at a designated sensing terminal. The introduction of a conductive foreign object can disrupt this magnetic symmetry, producing a non-zero voltage that reliably signals the presence of the object. This balanced coil approach may be combined with the thermal imaging approach described below to provide a multi-modal foreign object detection system.

### 2. Thermal Transfer Device

A thermal transfer device may be included in the base housing to improve the transfer of thermal energy away from the wireless charging surface 3104 and the electronics (e.g., 4102, 4104, 4350) contained within the base housing. The thermal transfer device may be positioned near or thermally coupled to the transmitter coil assemblies 4100a, 4100b. For example, the thermal transfer device may be coupled to a heat spreader of each transmitter coil assembly 4100a, 4100b. The thermal transfer device may also serve as a structural member that reinforces the base housing, given the mechanical loads imposed by the weight of the robot 1 during charging.

The thermal transfer device is a plate with a network of channels formed on at least one substantially planar surface. The network of channels increases the surface area of the thermal transfer device and may also be configured to direct airflow generated by the active cooling system 5000. The thermal transfer device is positioned rearward of the transmitter coil assemblies 4100a, 4100b and coupled to the rear interface portion of the base frame. Each of the coil assemblies 4100a, 4100b include a heat spreader and one or more layers of thermal interface material (TIM) layer to dissipate heat generated by the wireless power transmitter device 4020. Each heat spreader may be further coupled to the thermal transfer device by thermal conductors which extend from the heat spreader to the thermal transfer device. The thermal conductors are configured to absorb and conduct the heat energy away from the carriers toward the thermal transfer device. The thermal conductors may be embodied as heat pipes, vapor chambers, or any other known high-efficiency passive thermal conductive structure.

The heat spreaders, thermal conductors, and/or the thermal transfer device can be fabricated from a variety of metallic or other heat-conducting materials. For example, aluminum alloys, such as 6063 and 6061, are frequently employed in thermal transfer devices due to their favorable balance of good thermal conductivity, ease of formability via processes like extrusion, and cost-effectiveness. For applications demanding higher thermal performance, copper or copper alloys may be utilized, offering significantly enhanced thermal conductivity compared to aluminum. Furthermore, for scenarios that call for even higher thermal management capabilities, advanced materials such as annealed pyrolytic graphite or graphite composites could be considered. These materials are renowned for their highly anisotropic thermal conductivity, exhibiting exceptionally high conductivity along specific planes. In highly specialized implementations, liquids (e.g., water, glycol, liquid metal alloys) within sealed channels could be explored for their remarkably efficient heat transfer properties. The final selection of materials for the heat spreaders and the thermal transfer device can be based on factors such as the anticipated thermal load, spatial constraints, weight considerations, and the target manufacturing cost.

### 3. Transmitter Electronics

The wireless power transmitter device 4020 may include the power supply unit 4102, one or more charging controllers 4104, and a temperature sensor. The one or more charging controllers 4104 may be communicatively coupled with a computing device 4350 that may interface with other components (e.g., sensors, transceivers, controllers) housed in the charging system 3000. The one or more charging controllers 4104 may be coupled to respective transmitter coil assemblies 4100a, 4100b, where the one or more charging controllers 4104 receive power from a power supply unit 4102. The one or more charging controllers 4104 and power supply unit 4102 are housed in the base housing of the charging mat assembly 3100. The power supply unit 4102 supplies power to the one or more charging controllers 4104 which regulate the power delivery to the coils. The power supply unit 4102 may include power factor correction (PFC) circuitry configured to maintain a high power factor and reduce harmonic distortion on the input AC mains supply.

The one or more charging controllers 4104 includes left and right transmitter power electronics and a transmitter controller 4312. The left and right transmitter power electronics of the one or more charging controllers 4104 may be embodied as printed circuit board assemblies (PCBAs) configured to be coupled to the base support plate. Similarly, the power supply unit 4102 may be configured on a main PCBA. The main PCBA may further include or be coupled with a computing device 4350 that includes a processor and memory. The transmitter controller 4312 may be a microprocessor (e.g., MCU) coupled to both transmitter power electronics, individual microprocessors coupled to respective transmitter power electronics, or the computing device 4350 electrically coupled to both transmitter power electronics, where the computing device 4350 may also execute other functions.

The power supply unit 4102 and the one or more charging controllers 4104 are configured to be coupled to the base support plate. These electronics are configured to be protected from electromagnetic interference via a PCBA shield and protected from electrical shorts via insulating films. In other embodiments, the power supply unit 4102 and the one or more charging controllers 4104 may be arranged in a different manner. In other embodiments, the power supply unit 4102 and the one or more charging controllers 4104 may reside in a separate housing, where they are electrically coupled to the transmitter coil assemblies 4100a, 4100b in the charging mat assembly 3100. The PCBA shield may be formed from a conductive enclosure or a grounded metallic layer that attenuates both radiated and conducted EMI from the switching electronics.

The transmitter power electronics may incorporate a resonant circuit design to enhance power transfer efficiency. This design could include strategically placed capacitors in series or parallel with the primary coils to form a resonant tank circuit that is precisely tuned to the operating frequency. By achieving resonance, the system minimizes reactive power losses and maximizes the efficiency of energy transfer. The resonance frequency may be dynamically adjusted to accommodate variations in load impedance or environmental factors. For example, the transmitter power electronics may include DC-to-AC inverters, such as H-bridge inverters, which are shown as DC converters, and matching networks that optimize power transfer efficiency by matching the impedance of the inverter to the coil.

The transmitter power electronics may include a variable frequency drive (VFD) or a phase-locked loop (PLL) control system to dynamically adjust the operating frequency in response to real-time coupling conditions. As the robot 1 moves or shifts its position slightly during charging, the optimal coupling frequency may change due to variations in alignment and load impedance. A feedback loop incorporating impedance sensing and frequency tuning algorithms can continuously optimize the operating frequency, ensuring maximum power transfer efficiency while preventing detuning effects that could reduce charging performance. In some embodiments, the feedback loop may also incorporate a digital signal processor (DSP) configured to perform fast Fourier transform (FFT) analysis of the coil current waveform to detect and compensate for harmonic distortion.

To achieve higher efficiency and reduced power losses, the power electronics could leverage wide-bandgap semiconductor devices such as gallium nitride (GaN) or silicon carbide (SiC) transistors. These materials enable operation at significantly higher switching frequencies with lower on-state resistance and switching losses compared to traditional silicon-based components. This advancement allows for more compact, lightweight power converters with improved thermal performance and reduced heat dissipation, making them ideal for high-power wireless charging applications. Additionally, the charging mat assembly 3100 could incorporate a matrix of individually addressable coils, controlled through an intelligent coil selection algorithm. By selectively activating only the coils directly beneath the robot's feet 92, the system optimizes energy distribution, minimizing electromagnetic interference and improving overall system efficiency. This adaptive approach ensures compatibility with robots of various sizes and foot stances while reducing unnecessary energy dissipation in unoccupied regions of the mat.

### iv. Support Frame Assembly

The support frame assembly 3200 includes (i) a flared base 3110 that is integrated with or coupled to the rear interface portion of the base housing of the charging mat assembly 3100, (ii) a vertical support portion that extends generally upward from the flared base 3110, and (iii) a support cradle 3300 configured to extend over the charging mat assembly 3100 to couple with and support the robot 1. The materials for each component may be selected to optimize its particular performance characteristics. In some embodiments, the base housing may be constructed from a high-density, weighted polymer composite to provide a low center of gravity and improved stability against tipping, while the support frame assembly 3200 may be formed from polymers, plastics, aluminum, or steel. In other embodiments, the support frame assembly 3200 may be formed from a fiber-reinforced composite material, such as carbon fiber reinforced polymer (CFRP) or glass fiber reinforced polymer (GFRP), to achieve a favorable strength-to-weight ratio.

The support cradle 3300 is positioned in a forward-projecting, cantilevered manner relative to the vertical support portion. This configuration allows the robot 1 to reverse backward into the support cradle 3300 for docking. This cantilevered design also ensures that the robot 1, when coupled with the charging system 3000, is inherently stable by keeping the robot's center of mass positioned directly over the most stable part of the charging mat assembly 3100, for example, the center 3120 of the mat. The wide stance of the charging mat assembly 3100 relative to the overall height of the support frame assembly 3200 also increases the stability of the charging system 3000. This enables the robot 1 to be positioned in a forward-facing direction, wherein the support frame assembly 3200 and support cradle 3300 are positioned a predetermined distance that places the center of gravity of the robot 1 proximal to the center 3120 of the charging mat assembly 3100, and/or places the robot's 1 feet 92 proximal to the center 3120 (e.g., in a target "sweet spot" of the charging coils).

The support frame assembly 3200 is designed to extend upwards from the charging mat assembly 3100 to engage with the posterior and lateral aspects of the robot 1. Specifically, the support cradle 3300 is configured to engage with the robot 1 at its waist 604. In this engaged position, the robot 1 maintains a natural, upright posture, and the cradle provides robust, multi-axis mechanical support, which effectively offloads the static gravitational load from the robot's own actuators onto the structure of the charging system 3000. The upright posture may be conducive to long-term autonomous operation by allowing the robot 1 to be physically supported by the support frame assembly 3200 while simultaneously being positioned for receiving wireless charging power via the charging mat assembly 3100. Additionally, this upright posture may be advantageous for operations in human-centric environments where available floor space may be limited, and where the robot 1 should maintain a minimal physical footprint to avoid causing an obstruction. By offloading the gravitational load, the actuators in the robot 1 may enter a low-power or sleep state during docking, which may reduce the overall power consumption of the robot 1 and may allow a greater proportion of the received charging power to be directed to the battery pack 202.

In various embodiments, the support frame assembly 3200 may be removably attached to the charging mat assembly 3100. In some embodiments, the support frame assembly 3200 may be removably attached using quick-release mechanical and electrical attachments or connectors, allowing for a modular system. In other embodiments, the support frame assembly 3200 may be permanently attached, adjustable, wall or floor mountable, or omitted entirely to provide just the charging mat assembly 3100 for opportunity charging scenarios. The quick-release attachments may include tool-less latches, cam-lock mechanisms, or bayonet-style connectors that permit rapid disassembly and reassembly by a single operator.

### v. Flared Base

The flared base portion 3110 is configured to couple to the rear interface portion of the charging mat assembly 3100. As shown in FIG. 7, the flared base 3110 has a triangulated structure having two legs or members that extend from each side 3118a, 3118b of a vertical support portion to couple at the left and right extents of the charging mat assembly 3100. The flared base portion 3110 includes an internal support structure, an upper support shell, and a lower support shell. The upper and lower support shells form a flare cavity configured to house components of the active cooling system 5000 and the sensor assembly, and to route wiring. An airflow channel, formed between the flared base 3110 and the charging mat assembly 3100, serves as an inlet for a thermal management system.

The flared base portion 3110 provides the mechanical interface at the rear interface portion of the charging mat assembly 3100. It serves as the structural transition between the vertical support portion and the charging mat assembly 3100 and provides a rigid connection between them. The various surfaces of the flared base portion 3110 may be formed with rounded inside corners 3114a, 3114b of each leg that couple to the charging mat assembly 3100, which substantially reduce the occurrence of concentrated point stresses and increase the overall strength and fatigue life of the support frame assembly 3200. The rounded corners 3114a, 3114b may have a radius of curvature selected to maintain a stress concentration factor below a predetermined threshold for the material from which the flared base portion 3110 is fabricated.

The internal support structure is configured to provide rigidity to the flared base 3110 and includes various mounting points, bosses, and features for positioning and securing internal components, such as fan assemblies and sensor modules. In various embodiments, the internal support structure may be fabricated from a range of materials selected for their structural properties, including metals such as aluminum or stainless steel, composite materials like carbon fiber, or high-strength engineering plastics. The mounting points within the internal support structure may include threaded inserts, snap-fit receptacles, or heat-staked bosses configured to retain the internal components under vibration and mechanical shock.

A flare cavity is defined between the shells and is open to the interior cavity of the vertical support portion. Power and/or data busses may pass through the flare cavity and/or the interior cavity to deliver power and/or communications between the charging mat assembly 3100 and electronic components housed within the support cradle 3300. Further, the lower support shell may include a collection of air inlets (e.g., through apertures) configured to permit ambient air to enter the flare cavity for the active cooling system 5000. The air inlets may include mesh screens or filters configured to prevent the ingress of particulate matter, dust, or debris into the flare cavity, which could otherwise accumulate on internal components and degrade thermal performance over time.

By transitioning from the narrow profile of the vertical support portion to a much wider footprint at its base, the flare shape increases the stability of the charging system 3000 against tipping. This flared shape also serves to distribute the stress from any load applied to the support frame assembly 3200 over a much larger area of the charging mat assembly 3100. The angled surfaces of the flare also act as integrated gussets, creating a naturally rigid triangulated structure that efficiently translates any lateral and bending forces into tension and compression, thereby providing substantial reinforcement to the overall structure. This method of construction, which in some embodiments can be achieved through a process like injection molding, casting, machining, or additive manufacturing, can result in a part that is both stronger and more rigid than a comparable bolted assembly.

### vi. Vertical Support Portion

The vertical support portion of the support frame assembly 3200 is configured to provide a structural support and a load path between the support cradle 3300 and the charging mat assembly 3100, via the flared base 3110. Further, the vertical support portion defines an interior cavity that provides a protected conduit through which one or more power and/or data busses may pass to deliver power and/or communications between the charging mat assembly 3100 and electronic components housed within the support cradle 3300. In the illustrative embodiment, the vertical support portion has a substantially ovoid profile, but in some embodiments the profile may be any geometric shape in cross-section, including circular, square, triangular, polygonal, or oval. The vertical support portion may include internal cable management features, such as clips, channels, or tie-down points, configured to secure the power and data busses within the interior cavity and to prevent the busses from contacting the inner walls of the vertical support portion during operation or transport.

### vii. Support Cradle

The support cradle 3300 is coupled to and projects forward from the vertical support portion of the support frame assembly 3200. The support cradle 3300 has a main cradle body that supports two outwardly extending cradle arms 3302a, 3302b. The support cradle 3300 includes a lower shell, a cradle shell, a rear shell, and a tail shell. The inner surface of the cradle 3300 is contoured to substantially match the complex three-dimensional geometry of the robot's waist 604. This contouring serves to distribute contact forces over a wide surface area, which prevents the creation of pressure points and ensures a snug, stable fit. In alternative embodiments, only a portion of the inner surface of the cradle 3300 may be contoured to substantially match the robot's exterior surface, or the inner surface of the cradle 3300 may not be contoured to substantially match the robot's exterior surface.

The cradle arms 3302a, 3302b are defined by the lower shell and the cradle shell. The cradle arms 3302a, 3302b have a cantilevered configuration relative to the vertical support portion that helps define a retaining aperture that provides vertical support as well as horizontal bracing for the rear and lateral sides of the robot 1. The cradle arms 3302a, 3302b extend symmetrically from the main cradle body and are formed with a curved shape to reduce point loads between the cradle arms 3302a, 3302b and the vertical support portion, thereby increasing the strength of the cradle arms 3302a, 3302b. Each cradle arm 3302a, 3302b terminates in a respective alignment post base 3304a, 3304b, from which a vertical alignment post 3306a, 3306b extends upward.

Side gripper pads 3310a, 3310b, which may be made from a durable elastomer such as polyurethane with a specified durometer measurement, are positioned on the inner surface of the cradle arms 3302a, 3302b. These pads are supported by support posts that extend through apertures defined in the cradle shell, in order to provide a soft, high-friction contact point, thereby helping to prevent any slippage without marring the exterior surface finish of the robot 1. A rear support pad 3312 is positioned centrally on the cradle in order to provide stable, anti-rotational support to the back of the robot's waist 604. The durometer measurement of the side gripper pads 3310a, 3310b may be selected within a range of Shore A 40 to Shore A 80 to provide a balance between conformability and structural support.

An access opening is formed through a rear extent of the main cradle body, allowing for the formation of a cradle handle. The upper rim of the support cradle 3300 is integrated into an ergonomic cradle handle, which allows for easy manual transportation and repositioning of the charging system 3000. The placement of the cradle handle at the top of the structure leverages the stand's center of mass, making it feel balanced and lighter to lift than its actual weight might suggest, which may improve usability for human co-workers. In some embodiments, the cradle handle can also permit the robot 1 to pick up and transport its own charging system 3000 to a new (e.g., possibly more optimal) recharging location. The cradle handle may be formed with a cross-sectional profile that is ergonomically shaped to distribute grip forces across the palm of a human hand, reducing fatigue during transport.

The cradle arms 3302a, 3302b are shaped to form a guiding, funnel-like U-shaped geometry. This shape provides a form of passive mechanical guidance, creating a wide entry point that naturally corrects for any minor lateral misalignments as the robot 1 reverses into the charging system 3000. Each cradle arm 3302a, 3302b terminates in a respective alignment post base 3304a, 3304b, from which a vertical alignment post 3306a, 3306b extends upward. This symmetry helps to simplify the docking process, as a symmetrical target is significantly easier for the robot's perception system to identify and model. The vertical alignment posts 3306a, 3306b of the cradle arms 3302a, 3302b are designed to function as part of a high-precision kinematic coupling and are designed to engage with corresponding concave recesses that are located on the waist 604 of the robot 1. This physical engagement provides definitive tactile feedback to the internal sensors of the robot 1 and ensures a highly repeatable final docked position. This high degree of precision is useful for optimizing the coupling efficiency for wireless power transfer, as even minor misalignments in the positioning of the coils can degrade the overall rate of charging.

A rear support pad 3312 is coupled to the main cradle body, where the support cradle 3300 is coupled to the vertical support portion. The rear support pad 3312 is positioned centrally to provide stable, anti-rotational support to the back of the robot's waist 604, as well as a soft, high friction contact point, preventing slippage without marring the robot's exterior finish. A communication transceiver 3400 is arranged within the structure of the cradle handle in order to facilitate high-bandwidth data communication with a corresponding transceiver 604.34 that is located on the robot 1 when it is docked. The charging system 3000 is configured such that when the robot 1 is received into the support cradle 3300 and docked, the communication transceiver 604.34 of the robot 1 and the communication transceiver 3400 of the charging system 3000 are substantially parallel to each other and separated by only a small or minimal air gap (e.g., 5 mm, 1 cm, 2 cm, or 5 cm).

The profile of the vertical alignment posts 3306a, 3306b may have a tapered or chamfered top surface. This geometry acts as a mechanical lead-in, effectively capturing the corresponding recess on the robot 1 and actively guiding it into final alignment, making the system more tolerant of small initial positional errors during the docking maneuver. While the primary function of the vertical alignment post 3306a, 3306b is mechanical, its precise and highly repeatable engagement could make it a desirable location for incorporating additional functionalities. In some embodiments, the vertical alignment post 3306a, 3306b can be configured to serve as a multi-function interface. For example, the vertical alignment post 3306a, 3306b can be equipped with robust, spring-loaded electrical contacts that are designed to mate with corresponding conductive pads located within the recess of the robot's waist, thereby establishing a direct, high-amperage wired charging connection. This connection can be used to supplement the primary wireless charging system, thereby offering redundancy or enabling even higher-power rapid charging modes. In some embodiments, the vertical alignment posts 3306a, 3306b can be configured to include various sensors that can be used to verify a nominal docking. For example, the vertical alignment posts 3306a, 3306b can be configured to include integrated load cells, such as strain gauges, that can be used to measure the amount of weight that is being placed upon each vertical alignment post 3306a, 3306b, in order to determine whether the robot 1 is fully docked and/or to determine that the robot 1 is evenly balanced upon the support cradle 3300. An uneven pressure distribution detected by the load cells would signal a misalignment, thereby prompting the behavior manager 1350 of the robot 1 to make subtle micro-adjustments to its posture.

### viii. Electronics Assembly

The electronics assembly of the charging system 3000 may include a computing device 4350, a sensor assembly, and a communications transceiver 3400. The electronics assembly may be coupled to the wireless power transmitter device 4020 and the active cooling system 5000 for integrated control of various systems. The computing device 4350 may include or be coupled with one or more processors (e.g., transmitter controller 4312) contained in the charging system 3000. Additionally, the sensor assembly, the communications transceiver 3400, the wireless power transmitter device 4020, and the active cooling system 5000 may be communicatively coupled to the computing device 4350. The electronics assembly may further include a non-volatile memory configured to store configuration parameters, charging logs, and firmware for the charging system 3000.

### ix. Computing Device

The computing device 4350 includes any combination of hardware, software, and circuitry to perform various computing functions that enable the charging system 3000 to operate semi- or fully-autonomously. Such functions may include current limiting, load balancing, coordinating with other charging stands, processing sensor information, communicating with the humanoid robot 1 based on the sensor information and goals, controlling the activation or deactivation of electrical components, and policy management. The computing device 4350 may also execute fault detection and isolation (FDI) algorithms configured to identify degraded or failed subsystems within the charging system 3000 and to communicate such faults to a fleet management system or to the robot 1 itself.

The computing device 4350 may operate as one or more general purpose processors or special purpose processors (e.g., digital signal processors, application specific integrated circuits (ASICs), field programmable gate arrays (FPGAs), etc.) that may be configured to execute computer-readable program instructions. Such instructions may be executed to provide controller operations for the charging system 3000. Specifically, the charging stand 3000 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

The computing device 4350 may incorporate machine learning algorithms to analyze historical charging data, adapt power delivery parameters, and optimize charging performance over time. By monitoring factors such as the robot's movement patterns, battery charge-discharge cycles, and environmental influences, the system can fine-tune parameters such as duty cycle, voltage, and resonance tuning. Predictive analytics may be employed to preemptively adjust charging characteristics, extending battery longevity. The machine learning algorithms may include regression models, neural networks, or reinforcement learning agents trained on fleet-wide charging data aggregated from multiple charging systems 3000 and multiple robots 1.

### x. Sensor Assembly

In the illustrative embodiment, the sensor assembly includes (i) a first base sensor 3113a and a second base sensor, which are electrically connected by (ii) a sensor cable assembly. The base sensors 3113a are located on the angled surfaces of the flared base 3110. The base sensors 3113a are configured to monitor the state of the charging mat assembly 3100 and the immediate docking area. In general, the sensors 3113a are positioned for monitoring the charging mat assembly 3100 and are configured to perform functions such as foreign object detection, thermal monitoring, and/or providing visual data to aid the robot 1 during its docking maneuvers. The base sensors 3113a may be enclosed in sealed, IP-rated housings to protect against dust and moisture ingress in industrial operating environments.

The sensor cable assembly electrically connects the base sensors 3113a to the main electronics. It is configured to provide power to the base sensors 3113a, as well as to facilitate communications between the base sensors and other electronic systems of the charging system 3000. In some embodiments, the sensor cable assembly can be based upon existing wired communications standards, such as USB or power-over-ethernet (PoE), to simplify integration. The sensor cable assembly may include strain relief features at each termination point to prevent conductor fatigue and ensure long-term connection reliability.

In some embodiments, expanded vision-based sensors, such as additional wide-angle or thermal imaging cameras, can provide the robot 1 with enhanced data for precise alignment and safety monitoring. To mitigate risks associated with inductive charging, an enhanced metallic debris detection system may be employed, using inductive or Hall-effect sensors to detect foreign objects and trigger a self-cleaning mechanism, such as a wiper blade or a directed burst of compressed air. For diagnostics, small cameras, steerable endoscopes, or ultrasonic probes may be mounted within the support cradle 3300 to conduct an automated "health check" of the robot's critical components during a charging cycle. The system could also serve as a calibration fixture, using integrated cameras and lasers to verify the calibration of the robot's own sensor suite (e.g., LiDAR, cameras) while it is held in a known, stable position.

### 1. Foreign Object Detection

In some embodiments, the base sensors 3113a can be designed to detect the presence of the robot 1 or foreign objects and debris on the flat base platform portion 3102. The detection of foreign objects or debris can trigger an alert to notify the robot 1. The robot 1 may respond to the alert by halting the docking procedure to prevent it from attempting to dock in a condition that could present a tripping hazard or that could impede the proper placement of its feet 92 for charging. In some embodiments, the alert may also be transmitted to a fleet management system or a human operator via the communication transceiver 3400 or a separate network interface.

The sensors 3113a may include a system for metallic object detection to mitigate a significant safety risk. The powerful, high-frequency oscillating magnetic field generated by the charging coils can induce strong eddy currents in any nearby conductive material. If metallic debris (e.g., stray screws, metal shavings, or staples) is present on the wireless charging surface 3104, these induced eddy currents will cause the debris to heat up rapidly and intensely. This presents a potential hazard and can cause severe thermal damage to the charging pad surface and to the soles of the robot's feet 92. To prevent this, various embodiments of the sensors 3113a can include magnetic, inductive, photoelectric, infrared, or any other suitable type of detectors. An inductive sensor, for instance, can generate its own low-power magnetic field and can detect any disturbances to that field caused by the presence of metallic objects. Alternatively, a magnetic sensor, such as a Hall effect sensor, could be used to detect anomalies in the primary magnetic field when the charging coils are energized at a very low, pre-check power level. Upon the detection of a metallic object, the charging sequence would be immediately aborted, and an error signal would be transmitted. This error signal could trigger a notification that the charging system 3000 requires manual inspection and cleaning. Alternatively, the error signal or notification could be used to request that the robot 1 first clean the charging system 3000 before initiating a charging cycle. In an alternative embodiment, the charging system 3000 may include a wiper blade or other self-cleaning method that is activated upon detecting the presence of a metallic object.

The sensors 3113a may be vision-based, incorporating one or more small, wide-angle cameras. These cameras can provide the robot 1 with a close-up, downward-looking view of the flat base platform portion 3102. This additional visual data can be used to further enhance docking precision. For example, the wireless charging surface 3104, the support frame assembly 3200, or any other aspect or multiple aspects of the charging system 3000 could be augmented with high-contrast visual cues, such as painted foot outlines or embedded fiducial markers (e.g., QR codes or AprilTags). The vision-based sensors would be positioned and calibrated to detect these cues. The robot's perception system could then use this imagery to perform a final visual servoing sub-routine, making micro-adjustments to the position and orientation of its feet 92 to align them precisely with the target markings. This provides a redundant layer of positioning validation, which supplements data from the robot's own cameras and its internal odometry and proprioception, thereby increasing the overall success rate of the docking maneuver, particularly in environments with variable lighting or where minor disturbances could occur.

In some embodiments, these sensors 3113a can include thermal imaging sensors. Such sensors would be configured to create a continuous, real-time thermal map of the wireless charging surface 3104. The data from these thermal imagers can be processed to detect hotspots, which could be indicative of poor coil alignment, the presence of non-metallic debris causing thermal insulation, or a malfunction in the charging components themselves. The data from these thermal imagers can also be used to control the active cooling system 5000. The thermal map data may be stored in the computing device 4350 and analyzed over multiple charging cycles to identify trends in thermal behavior that may indicate component degradation.

Upon detecting a temperature that exceeds a predefined safe operational limit, the system can engage in a closed-loop thermal management protocol. This protocol could involve automatically reducing, or throttling, the charging current to lower the rate of heat generation, or it could involve activating the charging system's active cooling systems at a higher intensity. This ensures that the system operates safely and prevents thermal damage to the charging pad or to the robot's feet 92. Furthermore, this thermal data can be logged over time and transmitted to a central command center. By analyzing the thermal history of each charging cycle, it becomes possible to perform predictive maintenance, identifying trends that might indicate a degrading component in either the charging system 3000 or a specific robot 1 before a failure can occur.

In an embodiment wherein the sensors 3113a are realized as thermal imagers, the foreign object detection system can operate on the principle of thermal-signature analysis. This method can provide a direct confirmation of a thermal hazard by measuring the temperature of objects within their field of view. The operational sequence may involve a "heat and detect" protocol, wherein the charging controller 4104 energizes the transmitter coil assemblies 4100a, 4100b for a brief, predetermined duration (e.g., 2-3 seconds) prior to the initiation of a full charging cycle. This brief energization can be sufficient to induce eddy currents in any metallic foreign objects, such as a screw or paper clip, causing their temperature to rise measurably. The sensors 3113a, which may be uncooled VOx microbolometer sensors such as the Infisense Tiny1-C or FLIR Lepton, can continuously monitor the surface and can be configured to detect any localized temperature increase, or "hotspot," that exceeds a predefined safety threshold. For example, the system may be configured to trigger a fault condition and abort the charging sequence if an object's temperature is projected to exceed a limit stipulated by safety standards, such as IEC 62368-1 (e.g., 70° C or 120° C). This method is reactive, as it detects a hazard that is already beginning to manifest, but its directness provides undeniable proof of a thermal risk.

### xi. Communication Interface

The electronics assembly may include a communication transceiver 3400 or other means of data communication configured to communicate with the robot 1. In the illustrative embodiment, the communication transceiver 3400 is positioned in the support cradle 3300 and configured to couple with a corresponding wireless transceiver 604.34 positioned within the waist portion 604 of the robot 1. When docked, the two transceiver assemblies are brought into a face-to-face arrangement, separated by a small or minimal air gap (e.g., 5mm, 1cm, 2cm, 5cm). This close-proximity, high-bandwidth link allows the robot 1 to offload large volumes of sensor data or receive major firmware updates while docked. The external support provided by the cradle 3300 allows the robot 1 to maintain stable alignment between the transceivers to maintain wireless high-bandwidth communications with the charging system 3000. In other embodiments, the charging system 3000 may be configured with other means of data communication, including optical (e.g., Li-Fi), wired contact-based, or lower-frequency radio frequency links.

The communication transceiver 3400 may be communicatively coupled to other electronic components of the charging system 3000 and/or to external systems by means of a communication bus. For example, the communication bus can be a 10GBase-T ethernet cable (e.g., a CAT-6, CAT-6a, or CAT-7 cable) routed to extend down through the interior cavity of the vertical support portion to connect to compatible transceivers that are located in the vertical support portion, in the charging mat assembly 3100, and/or to exit the charging system 3000 for connection to other external equipment (e.g., to plug into a wall-mounted ethernet jack that is connected to a local area network (LAN)). In operation, the communication transceiver 3400 acts as a wired-to-wireless communication bridge in order to provide high bandwidth, bidirectional communication between the robot 1 and the charging system 3000 and/or other external systems and servers. In some embodiments, the communication bus may support Power over Ethernet (PoE) to supply electrical power to the communication transceiver 3400 and other low-power electronics within the support cradle 3300 via the same cable.

### xii. Active Cooling System

The WPT system 4000 can generate a great deal of heat during operation. The overall arrangement of the WPT system 4000 and active cooling system 5000 is configured to facilitate the removal of thermal energy. The active cooling system 5000 generates an air flow path through portions of the charging mat assembly 3100 and the support frame assembly 3200 to cool components of the WPT system 4000 in the charging system 3000. This integrated thermal management infrastructure is configured to mitigate heat generated during high-power wireless charging operations, thereby supporting desired performance, longevity, and operational safety of the charging stand 3000 and the robot 1.

The active cooling system 5000 includes: (i) a pair of fan assemblies, (ii) a pair of air ducts, (iii) a thermal transfer device, and (iv) a heat spreader assembly integrated within the charging system 3000. The fan assemblies, also referred to as air moving devices, are arranged within the support frame assembly 3200 and configured to generate the air flow path. The air ducts are coupled to an outlet of a respective fan assembly to receive air drawn in through inlet apertures formed in the support frame assembly 3200 by the fan assemblies and direct the air toward the thermal transfer device. The thermal transfer device is configured to receive thermal energy or heat generated by the WPT system 4000. The thermal transfer device is positioned within the air flow path so that air exhausted by the fan assemblies flows along the thermal transfer device (e.g., plurality of heat transfer features or a network of channels). In this way, heat is transferred to the flowing air from the components of the wireless power transmitter device 4020 in thermal communication with the thermal transfer device. The heat spreaders are coupled to the thermal transfer device to dissipate heat generated by the wireless power transmitter device 4020 and transfer the heat from the transmitter coil assemblies 4100a, 4100b to the thermal transfer device.

The thermal transfer device is arranged within the flared base 3110 and positioned to receive heat from the thermal conductors and receive the focused airflow generated by the fan assemblies and directed through the air ducts. The ducted arrangement is configured to direct the air through the channels of the thermal transfer device, which facilitates convective heat transfer for the dissipation of thermal energy generated during the charging process and carried away from the carriers and to the heat transfer device by the thermal conductors. The geometry of the channels within the thermal transfer device may be selected to achieve a target pressure drop and heat transfer coefficient, with channel widths and fin spacings optimized for the volumetric flow rate produced by the fan assemblies.

The active cooling system 5000 generates an air flow path through portions of the charging mat assembly 3100 and the support frame assembly 3200 to cool components of the WPT system 4000 in the charging system 3000. The operational cycle of the active cooling system 5000 is initiated by the aspiration of ambient air into the charging system 3000. The fan assemblies draws in or ingests air through one or more inlet apertures defined within the flared base 3110. The fan assemblies then exhaust the air through the air ducts toward the thermal transfer device, whereupon the air is made to traverse the thermal transfer device. During its passage through the structure of the thermal transfer device, the airflow effectuates a thermodynamic exchange via forced convection, wherein the moving air absorbs waste thermal energy that has been conducted to the thermal transfer device from its source, namely the electronic components of the wireless power transfer (WPT) system 4000. Following this heat absorption, the now-heated, or thermally energized, air is exhausted from the charging system 3000. The air is exhausted out of one or more outlet ends from the rear of the charging mat assembly 3100 and into the surrounding environment. This cycle of cool air intake and warm air expulsion provides a mechanism by which the active cooling system 5000 is configured to regulate the operational temperature of the internal electronic components, maintaining them within their specified design limits, which can contribute to system reliability and longevity.

The active cooling system 5000 is configured as a modular and readily replaceable or interchangeable component, offering significant advantages in terms of manufacturing, maintenance, and potential future upgrades. This thermal management strategy can contribute to maintaining operating temperatures within the charging system 3000, mitigating component degradation, and supporting consistent power transfer. The illustrated examples provided in the figures show the integrated nature of these components, demonstrating how the wireless charging elements may be cooled to reduce overheating and support the operation of the charging system 3000 while charging the robot 1. In some embodiments, the fan assemblies may be variable-speed fans controlled by the computing device 4350, where the fan speed is modulated as a function of the temperature readings from the sensor assembly to balance thermal performance against acoustic noise generation.

### F. OPERATION OF WIRELESS POWER TRANSFER SYSTEM

Referring again to FIGS. 5-6, in conjunction with FIG. 7, the WPT system 4000 is configured to transfer power from the charging system 3000 to the robot 1 via electromagnetic induction.

### a. Wireless Power Transfer

As illustrated in FIGS. 5 and 6, with each of the robot's receiver coil assemblies 936a, 936b positioned, the wireless power transmitter device 4020 may create an oscillating magnetic field 4150 in the first and second transmitter coils 4100a, 4100b to transfer power to the receiver coil assemblies 936a, 936b of the robot 1. An alternating electric current is created in each receiver coil assembly 936a, 936b, which is passed through the receiver charging controller 888 to convert the AC power into DC power that may be used to charge the battery pack 202 of the robot 1. For example, each foot 92 may be configured with receiver coil assembly 936 to receive between 0.01-4kW (preferably between 0.5-2kW, and most preferably 1kW) per foot via the transmitter coils 4100 in the charging mat assembly 3100. Because the robot 1 has two feet, the power received by each foot can be doubled to determine the total power that the robot can receive at a given time. In some embodiments, the power delivered to each foot 92 may be independently controlled, such that one foot 92 receives a higher power level than the other foot 92 to compensate for differences in coil alignment or receiver coil assembly performance.

To facilitate alignment of the transmitter coils 4100a, 4100b and the receiver coil assemblies 936a, 936b, the robot 1 and charging system 3000 may establish a communication link. As the robot 1 navigates onto the charging mat assembly 3100 and positions itself in the support cradle 3300 of the charging system 3000, the communication transceiver 604.34 in the waist of the robot 1 comes in proximity of the communication transceiver 3400 positioned in the support cradle 3300 to create a communication connection. In particular, when the communication transceiver 604.34 and the communication transceiver 3400 are within about 5 cm, the robot 1 and charging system 3000 may establish communication to: (i) aid in positioning of each foot 92 to substantially align the receiver coil assemblies 936a, 936b with the first and second transmitter coils 4100a, 4100b, (ii) initiate power transfer, (iii) adjust the level of power being transmitted, and (iv) terminate power transfer when the battery pack 202 is at a predetermined charge level. In various embodiments, the established communication may be further utilized for data transfer while the robot 1 is charging. For example, the charging system 3000 may include a wired 10GBASE-T ethernet connection between the computing device 4350 and the communication transceiver 3400 for data offload from the robot 1 to the computing device 4350.

The robot 1 may be configured to continuously monitor the operational status of the battery pack 202, including but not limited to received voltage, battery charge state, and temperature, and to transmit this information back to the station computing device 4350 of the charging system 3000 as part of a closed-loop control architecture. This feedback mechanism permits the charging controller 4104 to affect real-time adjustments to the transmitted power, and further enables the cooperative monitoring by both systems for fault conditions and/or foreign object detection (FOD) events, thereby facilitating the immediate termination of power transfer should a hazardous condition be detected. In various embodiments, the communication link may be achieved through alternative protocols using a shared or dedicated wireless communication link, when high-speed data offload is not needed. The closed-loop control architecture may implement a proportional-integral-derivative (PID) controller or a model-predictive controller configured to regulate the charging current and voltage within predetermined tolerances.

### b. Data Communication

Referring to FIG. 6, the wireless power transfer system 4000 is configured to establish a data communication link between the communication interface 3400 in the charging system 3000 and the communication interface 604.34 in the robot 1 to assist in charging of the battery pack 202. For example, when communication is established, the robot 1 and the wireless power transmitter device 4020 may communicate information, including: (i) when the robot 1 is at or on the charging mat assembly 3100, (ii) when the robot 1 needs to reposition itself on the charging mat assembly 3100 and/or charging system 3000, (iii) when to begin charging, (iv) how fast to charge, (v) how much power to supply to the battery or how much to charge the battery, and (vi) when charging of the battery pack 202 is complete.

The data link communication systems disclosed can be configured to facilitate real-time information exchange between the charging system 3000 and the robot 1, optimizing power transfer efficiency and system performance. This allows real-time feedback to be continuously transmitted between the robot 1 and the charging system 3000, enabling dynamic adjustments to charging parameters such as voltage, current, and frequency for optimal power transfer efficiency. The data link may also carry diagnostic telemetry from the charging system 3000 to the robot 1, such as transmitter coil temperature, power supply status, and cooling system performance.

Furthermore, communication between the charging system 3000 and the robot 1 allows for real-time detection and mitigation of abnormal power levels. For example, if a sudden load change occurs while the wireless power transmitter device 4020 is delivering 1 kW of power, the wireless power transmitter device 4020 can immediately detect this anomaly and adjust the power output accordingly. This proactive adjustment reduces the need for complex hardware-based overcurrent protection mechanisms, improving system reliability and preventing potential damage to both the transmitter and receiver circuitry. Additionally, data communication can address misalignment issues in inductive or resonant wireless power transfer systems. Misalignment between the transmitting and receiving coils can lead to a decrease in power transfer efficiency due to a reduction in mutual inductance. By leveraging real-time data exchange, the system can detect variations in coupling efficiency and compensate by dynamically increasing the power output of the transmitter. This feature is particularly beneficial in robotic applications where precise positioning may not always be guaranteed due to movement, vibrations, or external disturbances.

### i. Alignment of Communication Transceivers

In some embodiments, the thickness, height, and/or other physical dimensions of the side gripper pads 3310a, 3310b, the rear support pad 3312, the alignment post bases 3304a, 3304b, and/or the vertical alignment posts 3306a, 3306b can be specifically selected to help set the final width of the air gap when the robot 1 is in its fully docked configuration. In some embodiments, the side gripper pads 3310a, 3310b, the rear support pad 3312, the alignment post bases 3304a, 3304b, and/or the vertical alignment posts 3306a, 3306b can be made to be adjustable, for example, to allow for the fine tuning of the size of the air gap and/or the final alignment of the transceivers 3400 and 604.34. In some embodiments, the side gripper pads 3310a, 3310b, the rear support pad 3312, the alignment post bases 3304a, 3304b, and/or the vertical alignment posts 3306a, 3306b can be designed to be interchangeable with other similar elements that have different physical dimensions. For example, the vertical alignment posts 3306a, 3306b could be exchanged for taller vertical alignment posts in order to slightly (e.g., by 1-2mm) raise the waist 604 of the robot 1 relative to the support cradle 3300, and thereby slightly elevate the transceiver 604.34 of the robot 1 relative to the communication transceiver 3400 of the charging system 3000. In some embodiments, the vertical alignment posts 3306a, 3306b can be configured with an offset or an eccentric adjustability feature, in which the vertical alignment post 3306a, 3306b slightly orbits around its respective alignment post base 3304a, 3304b in order to provide some degree of lateral adjustability that can be used to slightly alter the final position of the waist 604 relative to the support cradle 3300, and in turn slightly alter the fine alignment of the transceiver 604.34 relative to the transceiver 3400 when the robot 1 is in its docked state. The eccentric adjustability feature may include a set screw or a locking collar configured to retain the vertical alignment post 3306a, 3306b in a selected angular position once the fine adjustment has been completed.

The mechanical mating of the waist 604 of the robot 1 with the guiding surfaces of the support cradle 3300 ensures that this coaxial and coplanar alignment is achieved in a highly repeatable manner upon every single docking event. The system is designed to be robust enough to maintain this link despite potential minor misalignments, for example, of up to +/-15mm in the X and Y directions, a separation distance (Z range) of 0 to 25mm, and an angular misalignment of up to +/-10 degrees. This precise, mechanically-enforced positioning is an aspect of the operation of the millimeter-wave data link, as it places the respective transmitting and receiving antenna arrays in an ideal orientation for high-fidelity communication, thereby reducing or minimizing the signal path loss and increasing or maximizing the received signal strength. The mechanical repeatability of the docking interface may be characterized by a positioning accuracy of less than +/-2 mm and an angular accuracy of less than +/-1 degree over thousands of docking cycles.

In some embodiments, the materials of the support cradle 3300 can be specifically selected to further enhance the communication link between the two communication transceivers 3400 and 604.34. For example, the support cradle 3300 and/or the waist 604 of the robot 1 can be designed to include one or more layers of RF shielding or other attenuative materials in order to reflect or reduce any stray signals from the surrounding environment (e.g., from other nearby charging systems 3000) and thereby reduce their ability to interfere with the primary RF link that is established between the communication transceivers 3400 and 604.34. Conversely, the support cradle 3300 and/or the waist 604 can be configured to include one or more layers of RF shielding or attenuative materials to reduce or block the signals of the RF link between the communication transceivers 3400 and 604.34 from propagating out beyond the immediate vicinity of the charging system 3000 and the robot 1. Such signal attenuation can help to prevent any crosstalk between multiple RF links that may exist between multiple charging systems 3000 and multiple robots 1 operating in a close environment, and/or can help to improve data security by reducing the distance that any stray signals can propagate to be potentially detected by unauthorized eavesdroppers. The RF shielding layers may be formed from a conductive mesh, a metalized film, or a conductive polymer composite, each of which may be selected based on its attenuation characteristics at the operating frequency of the communication transceivers 3400 and 604.34.

### ii. High-Bandwidth Data Communication and Offload

Subsequent to the successful mechanical engagement of the humanoid robot 1 with the charging system 3000, which provides for advantageous physical stabilization, the docking procedure further facilitates the establishment of a high-bandwidth, short-range wireless data connection using a wireless data offload system. The wireless data offload system creates a connection to facilitate the rapid offloading of voluminous operational and sensory data sets that are generated and stored by the robot 1 during its operational cycles. The wireless data offload system includes a first communication transceiver 3400 positioned in the support cradle 3300 and a corresponding second wireless transceiver 604.34 positioned within the waist portion 604 of the robot 1. The offloading of these extremely large datasets is an architectural feature for an advanced robotics platform as it allows the robot 1 to collect operational data that can later be used by a cloud-based AI system 2780 to train, modify, alter, or generate new and/or more advanced models. This offload capability directly addresses the fundamental size, weight, power, and cost (SWaP-C) limitations that are inherent to any untethered, mobile humanoid platform.

The selection of the 60 GHz band, or other similar millimeter-wave frequency segments, allows for multi-gigabit data throughput. However, this choice of frequency also introduces significant technical challenges that are effectively addressed by the physical docking architecture. Millimeter-wave signals are characterized by very high path loss and are also subject to significant absorption by atmospheric oxygen, a phenomenon which peaks in the 60 GHz band. These physical phenomena can limit the effective transmission distance of such signals. To counteract this signal attenuation, the wireless data offload system can be designed to rely on high-gain, phased-array antennas that are capable of focusing the RF signal into a narrow, highly directional beam. While this technique concentrates the signal power quite effectively, it also creates a significant pointing and alignment consideration; a minor angular deviation between the transmitting and receiving antennas can cause the communication link to degrade or fail completely.

The robust mechanical interface of the charging system 3000 can effectively resolve this inherent trade-off. The docking maneuver essentially transforms a difficult mobile communication problem into a simpler quasi-static one. The process may be designed to function as a multi-stage connection protocol: an initial gross alignment is performed by the navigation system of the robot 1, a subsequent fine mechanical alignment is achieved as the physical contours of the waist 604 of the robot 1 mate with the support cradle 3300, and a final micro-alignment can then be performed electronically via beam-steering techniques within the transceivers themselves. This mechanically enforced proximity and alignment positions the respective transceivers 3400 and 604.34 such that only a narrow gap extends between them. This, in turn, greatly facilitates the subsequent electronic beamforming and link negotiation processes, thereby promoting the establishment of a stable, high-quality communication channel. This physical solution, while posing a significant design challenge, also affords a degree of inherent security against remote eavesdropping and also permits the high-density deployment of multiple charging system 3000 in close proximity to one another without causing mutual interference.

For the transfer of data from the robot 1 to the charging system 3000 to proceed without errors, the robot 1 is maintained in a stable and stationary configuration throughout the entire duration of the docking period. In some embodiments, the robot 1 is constrained by its behavior manager 1350 from initiating any locomotive or other significant motion relative to the charging system 3000 until such time as the data transfer protocol is either fully completed (e.g., as verified by a data integrity check such as a cyclic redundancy check (CRC)), or is otherwise intentionally terminated by a controlling system, such as the planner of the robot 1 or in response to an external directive from a command center. This strict protocol, which is made possible by the secure mechanical docking, serves to promote a high degree of integrity for both the high-frequency communication link and the data payload that is being transferred across it. In alternative embodiments, the data transfer may be performed using an incremental or resumable transfer protocol that permits the transfer to be paused and resumed without data loss if the robot 1 must undock before the transfer is fully complete.

The provision of this high-speed data interface permits the robot 1 to offload large, accumulated data logs. These logs may thereafter be relayed by the charging system 3000, which can act as a data conduit with its own potential internal buffering capabilities, to one or more remote command centers or to the cloud-based artificial intelligence system by means of a separate, high-speed network backhaul connection. In various embodiments, a robot 1 is equipped with a sensor array for collecting data during an operational runtime. The robot 1 is powered by a rechargeable battery 202. The system is configured such that the data transfer rate for offloading the collected data is significantly faster than the charging rate of the battery 202. This configuration ensures that data offloading does not become a bottleneck in the operational cycle of the robot 1, thereby maximizing the availability and uptime of the robot 1. The operational runtime may be of any duration, for example, a period of 1 hour, 2 hours, 3 hours, 4 hours, 5 hours, 6 hours, or any duration therebetween. During this runtime, the sensor array of the robot 1 continuously collects data. Upon completion of its task or when the battery 202 reaches a predetermined low-level threshold, the robot 1 connects to a docking station which provides both a data link and a battery charger.

### G. OPPORTUNITY CHARGING SYSTEMS

As previously discussed and with reference to FIG. 3, a charging system capable of providing power while the robot 1 is working (i.e., an opportunity charging system) may be advantageous to ensure that tasks performed by the robot 1 are efficiently completed and that the robot 1 has sufficient charge to complete the tasks. Opportunity charging enables the robot 1 to receive supplemental power during productive work periods, thereby reducing or eliminating the downtime associated with dedicated charging breaks. Therefore, the following embodiments focus on opportunity charging systems that are capable of providing power to the robot 1 in this way. Each of the following opportunity charging system embodiments shares the wireless power transfer principles described above in connection with the WPT system 4000, unless stated otherwise.

### a. Removable Support Frame Assembly

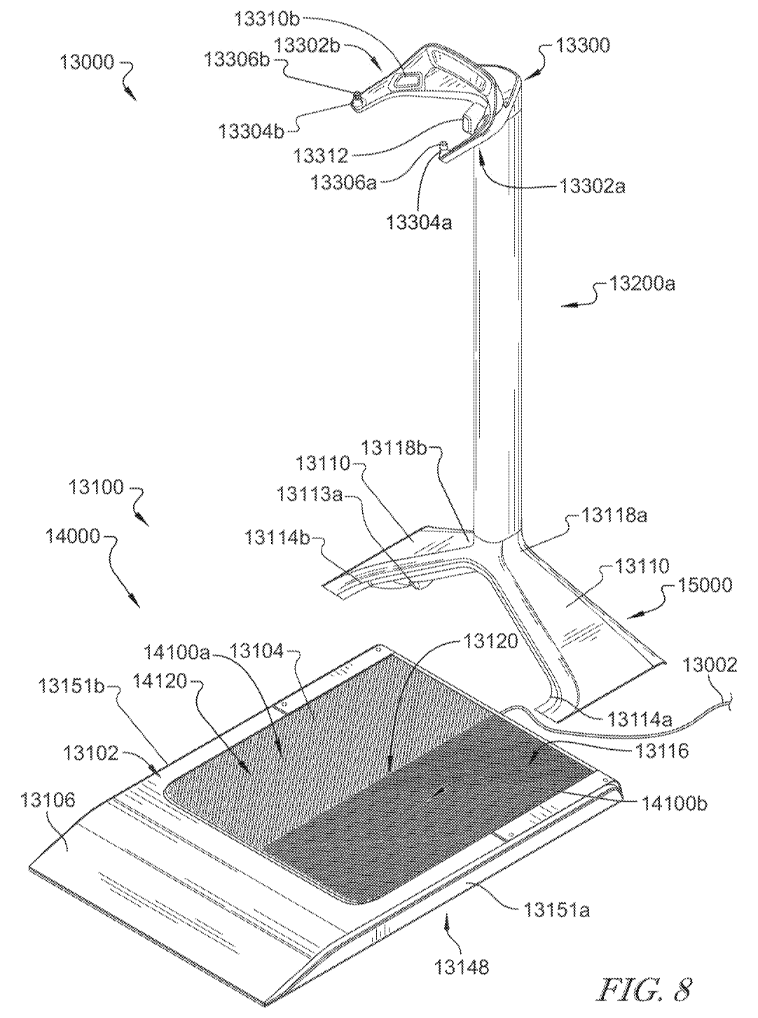

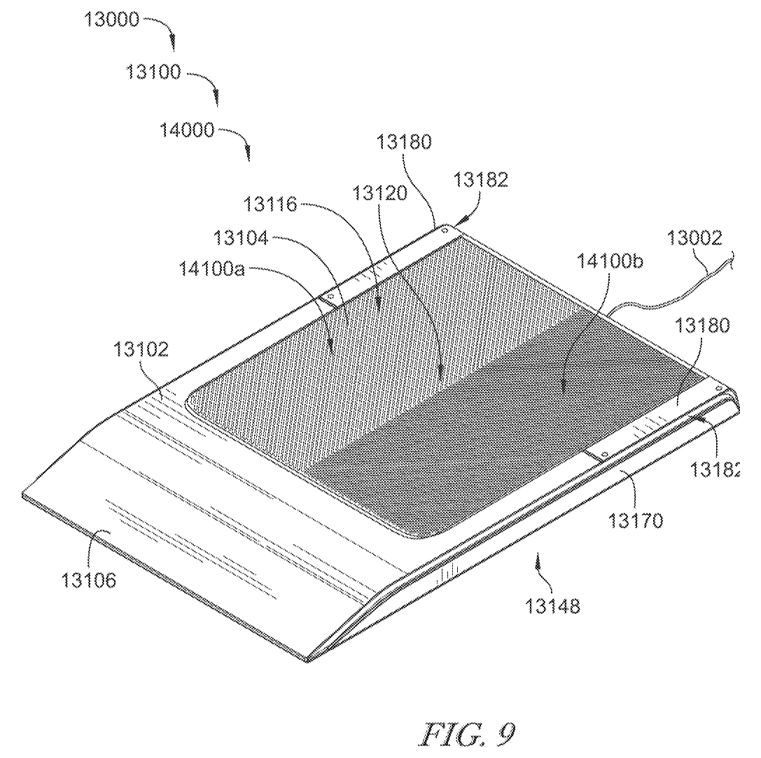

Similar to the charging system 3000 as described above, FIGS. 8-9 illustrate an opportunity charging system 13000 having a modular design to provide opportunistic charging for the robot 1. For the sake of brevity, the above disclosure in connection with the charging system 3000 will not be repeated below, but it should be understood that across embodiments, like numbers represent like structures. For example, the disclosure relating to WPT system 4000 applies in equal force to WPT system 14000. Further, it should be understood that the operational modes of the opportunity charging system 13000 are similar to, or identical to, those disclosed regarding the charging system 3000. Moreover, it is to be understood that any one or more features of the charging system 3000 can be used in conjunction with those disclosed regarding the opportunity charging system 13000, and that any one or more features of the opportunity charging system 13000 can be used in conjunction with those disclosed regarding the charging system 3000.

The primary difference between this first opportunity charging system 13000 and the above-described charging system 3000 is the fact that the support frame assembly 13200 is removable from the charging mat assembly 13100. Once the support frame assembly 13200 has been removed from the charging mat assembly 13100, a pair of cover plates 13180 may be coupled to the charging mat assembly 13100 to obscure the locations where the support frame assembly 13200 was coupled to the charging mat assembly 13100, providing a clean and safe surface. The first opportunity charging system 13000 may be disposed in various places within the robot's operational environment where the above-described charging system 3000 may not have been disposed due to the inclusion of the support frame assembly 3200. Accordingly, the robot 1 may be able to recharge its battery pack 202 within the robot's operational environment at more locations and thus perform tasks for longer duration and/or perform more tasks consecutively (i.e., without requiring a full re-charge) compared to when the robot's operational environment includes the above-described charging system 3000. The cover plates 13180 may be secured to the charging mat assembly 13100 using snap-fit connections, magnetic attachments, or threaded fasteners, and may be formed from the same material as the upper platform of the charging mat assembly 13100 to provide a uniform appearance and surface profile.

In addition, unlike the charging system 3000 that includes a communication transceiver 3400 positioned in the support cradle 3300, the charging system 13000 may include a similar communication transceiver (not shown) positioned within the charging mat assembly 13100, which may communicate with the communication transceiver 604.34 in the robot 1. In this regard, the communications transceiver 3400 shown in FIG. 6 may be representative of the communication transceiver included within the charging mat assembly 13100, as well as the other opportunity charging systems discussed herein.

### b. Second Embodiment of an Opportunity Charging System

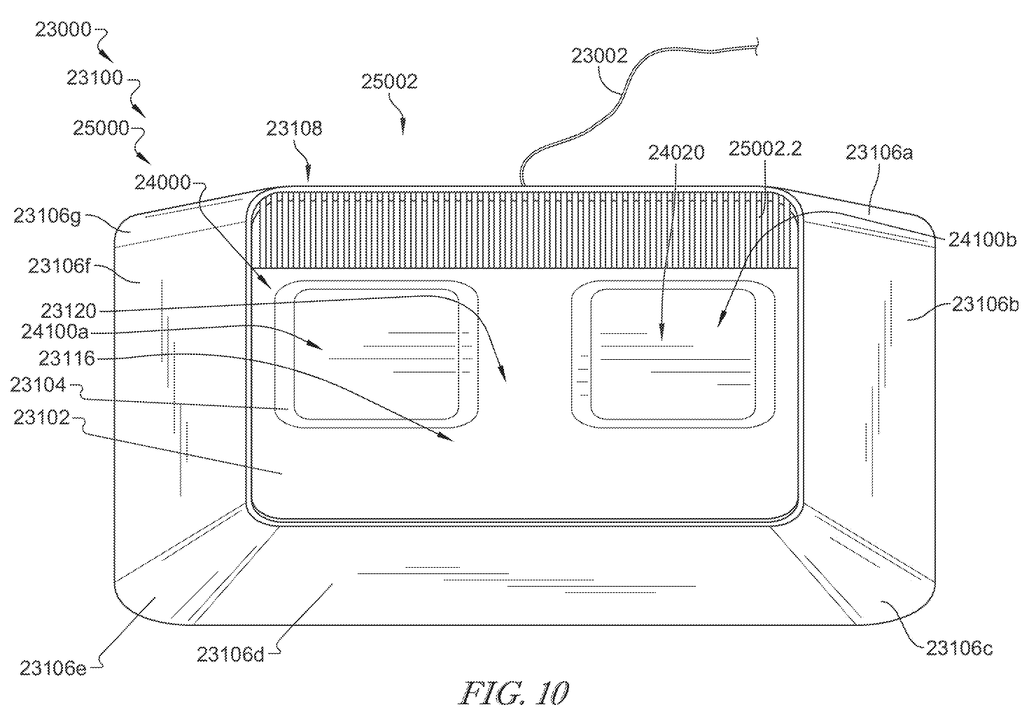

Similar to the charging system 3000 and the first embodiment of the opportunity charging system 13000 as described above, FIG. 10 illustrates a second embodiment of an opportunity charging system 23000 having a sloped design on three sides to provide opportunistic charging for the robot 1. For the sake of brevity, the above disclosure in connection with the charging system 3000 or the opportunity charging system 13000 will not be repeated below, but it should be understood that across embodiments, like numbers represent like structures. For example, the disclosure relating to WPT system 4000 applies in equal force to WPT system 24000. Further, it should be understood that the operational modes of the opportunity charging system 23000 are similar to, or identical to, those disclosed regarding charging system 3000. Moreover, it is to be understood that any one or more features of the charging system 3000 can be used in conjunction with those disclosed regarding the opportunity charging system 23000, and that any one or more features of opportunity charging system 23000 can be used in conjunction with those disclosed regarding the charging system 3000.

The primary difference between the opportunity charging system 23000 and the previously disclosed charging systems 3000, 13000 is the fact that opportunity charging system 23000 includes beveled edges 23106 on numerous sides and corners of the charging mat assembly 23100. According to the illustrative embodiment, the opportunity charging system 23000 includes beveled edges 23106a-g on three sides and each corner of the charging mat assembly 23100. The rear side 23108 to which the power cord 23102 is connected to may not be beveled. In other embodiments, the rear side 23108 may include a beveled edge and a recess within the beveled edge for which the power cord 23102 may pass therethrough. In the illustrative embodiment, the charging mat assembly 23100 is rectangle-shaped, however the disclosure is not limited thereto and the shape of the charging mat assembly 23100 may be any shape and the shape may include one or more beveled edges on the sides and/or corners. The active cooling system 25000 may include a vent 25002 having openings 25002.2 to facilitate the removal of thermal energy generated by wireless power transmitter device 24020 in the charging mat assembly 23100. The vent 25002 may be disposed at the rear side 23108 but the disclosure is not limited thereto.

The beveled edges 23106a-g may be integrated directly into the charging mat assembly 23100 design during manufacturing, or they may be provided as modular attachments that can be added to existing opportunity charging systems to upgrade their accessibility features. In the embodiment where the beveled edges 23106a-g can be added as modular attachments, the beveled edges 23106a-g may be coupled to the charger system 3000, 13000 using mechanical fasteners, magnetic connections, or snap-fit interfaces that allow for quick installation and removal without requiring tools. In some cases, the beveled edges 23106a-g may be designed with standardized mounting points that align with corresponding features on the vertical side walls of the mat, ensuring secure attachment and proper alignment with the wireless charging surface 23104. In some embodiments, the attachment mechanism for the removable beveled edges 23106a-g can be used to removably affix two opportunity charging systems 23000 to each other, thereby forming a larger contiguous charging area.

The beveled edges 23106a-g may be designed with the same ramped profile and dimensions as those used in the charging systems 3000, and/or 13000, ensuring consistent performance and compatibility across different opportunity charging system configurations. However, in other embodiments, the beveled edges 23106a-g may have different slopes based on the location and frequency of movement over that specific beveled edges 23106a-g. For example, the beveled edge 23106d at the front of the charging system 23000 may have a more gradual slope than the other beveled edges 23106a-c, 23106e-g to allow the beveled edge 23106d to meet accessibility regulations within the working environment. The multi-sided beveled edge configuration may be particularly advantageous in environments where robots need to approach opportunity charging systems from varying directions, as the beveled edges on multiple sides may reduce tripping hazards for both robots and humans traversing the location of the opportunity charging system. The beveled edges 23106a-g may also facilitate smooth passage for wheeled equipment such as material handling carts, dollies, or automated guided vehicles that may need to cross over or around the opportunity charging system 23000 during normal operations.

The opportunity charging system 23000 may be disposed in various places within the robot's operational environment where the above-described charging system 3000 may not have been disposed due to the robot's 1 ability to access the opportunity charging system 23000 from multiple directions via at least one of the beveled edges 23106a-g. Accordingly, the robot 1 may be able to recharge its battery pack 202 within the robot's operational environment at more locations and thus perform tasks for a longer duration and/or perform more tasks consecutively (i.e., without requiring a full re-charge) compared to when the robot's operational environment includes charging systems with other configurations. The multi-directional accessibility of the opportunity charging system 23000 may also reduce congestion and queuing delays when multiple robots 1 converge on the same charging location.

### c. Third Embodiment of an Opportunity Charging System

Similar to the charging system 3000 as described above, FIG. 11 illustrates a third embodiment of an opportunity charging system 33000 that includes a power conversion unit that contains the electronics that are described above as being contained in the charging mat assembly 3100. For the sake of brevity, the above disclosure in connection with the charging system 3000 will not be repeated below, but it should be understood that across embodiments, like numbers represent like structures. For example, the disclosure relating to WPT system 4000 applies in equal force to WPT system 34000. Further, it should be understood that the operational modes of the opportunity charging system 33000 are similar to, or identical to, those disclosed regarding charging system 3000. Moreover, it is to be understood that any one or more features of the charging system 3000 can be used in conjunction with those disclosed regarding the opportunity charging system 33000, and that any one or more features of opportunity charging system 33000 can be used in conjunction with those disclosed regarding the charging system 3000.

In general, the charging mat assembly 33100 is substantially similar to the charging mat assemblies 3100, 13100, and 23100, except some or all of the electronics have been moved from the interior of the charging mat assembly 33100 to an electronics assembly 34500 (e.g., an external power conversion unit). By removing at least some of the electronics found inside the prior charging mat assemblies (e.g., the communications transceiver 3400), the overall physical size (e.g., height) of the charging mat assembly 33100 can be reduced compared to the size (e.g., height) of the charging mat assemblies 3100, 13100, and 23100. As such, the opportunity charging system 33000 can be provided with a relatively thinner profile than the other opportunity charging mat assemblies 3100, 13100, and 23100. The thinner profile can be beneficial because it may reduce tripping hazards, and may allow for easier deployment of the opportunity charging system 33000. The reduced height of the charging mat assembly 33100 may also decrease the mechanical step height that the robot 1 must negotiate during docking, which may simplify the locomotion control algorithms executed by the robot 1.

This separated electronics configuration may be particularly advantageous in environments where space constraints limit the thickness of floor-mounted charging surfaces, or where centralized power management is desired for multiple opportunity charging systems. The modular design may also facilitate maintenance and upgrades, as the electronics assembly 34500 can be accessed and serviced independently of the charging mat assembly 33100. In some embodiments, the electronics assembly 34500 may be mounted on a wall to keep it elevated and out of the way of floor traffic, or it may be concealed under a desk or other furniture or equipment to maintain a clean workspace appearance and to present a reduced impediment to traversal (e.g., fewer tripping hazards). The electronics assembly 34500 may also be positioned behind other work floor equipment such as workbenches, storage units, or machinery to minimize its visual impact while maintaining accessibility for maintenance purposes. This flexible positioning capability may allow the electronics assembly 34500 to be integrated into existing work environments without disrupting established workflows or creating additional obstacles in high-traffic areas.

Additionally, the charging mat assembly 33100 may include beveled edges 33106a-d on every side of the charging mat assembly 33100. In the illustrative embodiment, the charging mat assembly 33100 is rectangle-shaped, however the disclosure is not limited thereto and the shape of the charging mat assembly 33100 may be any shape and the shape may include a beveled edge on every side of the charging mat assembly 33100. The all-sided beveled edge configuration provides the robot 1 with the ability to approach and step onto the charging mat assembly 33100 from any direction, which may increase the flexibility of workstation layout design and reduce constraints on the robot's path planning algorithms.

The beveled edges 33106a-d may be integrated directly into the charging mat assembly 33100 design during manufacturing, or they may be provided as modular attachments that can be added to existing opportunity charging systems to upgrade their accessibility features. In the embodiment where the beveled edges 33106a-d can be added as modular attachments, the beveled edges 33106a-d may be coupled to the charger system 33000 using mechanical fasteners, magnetic connections, or snap-fit interfaces that allow for quick installation and removal without requiring tools. In some cases, the beveled edges 33106a-d may be designed with standardized mounting points that align with corresponding features on the vertical side walls of the mat, ensuring secure attachment and proper alignment with the wireless charging surface 33104. In some embodiments, the attachment mechanism for the removable beveled edges 33106a-d can be used to removably affix two opportunity charging systems 33000 to each other. The wireless charging surface 33104 may include grooves 33104.2 and projections 33104.4. In other words, the wireless charging surface 33104 may not be a flat surface, and the grooves 33104.2 and projections 33104.4 may be configured to interlock with corresponding features on the soles of the robot's feet 92 to provide additional positional stability during charging.

The beveled edges 33106a-d may be designed with the same ramped profile and dimensions as those used in the charging systems 3000, 13000, and/or 23000 ensuring consistent performance and compatibility across different opportunity charging system configurations. However, in other embodiments, the beveled edges 33106a-d may have different slopes based on the location and frequency of movement over that specific beveled edge 33106a-d. A beveled edge configuration on all sides may be particularly advantageous in environments where robots need to approach opportunity charging systems from any direction, as the beveled edges 33106a-d on all sides also reduce tripping hazards for both robots and humans traversing the location of the opportunity charging system. The beveled edges 33106a-d may also facilitate smooth passage for wheeled equipment such as material handling carts, dollies, or automated guided vehicles that may need to cross over or around the opportunity charging system 33000 during normal operations.

The opportunity charging system 33000 may be disposed in various places within the robot's operational environment where the above-described charging system 3000, 13000, or 23000 may not have been disposed due to the robot's 1 ability to access the opportunity charging system 33000 from any direction via any of the beveled edges 33106a-d. Accordingly, the robot 1 may be able to recharge its battery pack 202 within the robot's operational environment at more locations and thus perform tasks for longer duration and/or perform more tasks consecutively (i.e., without requiring a full re-charge) compared to when the robot's operational environment includes charging systems with other configurations.

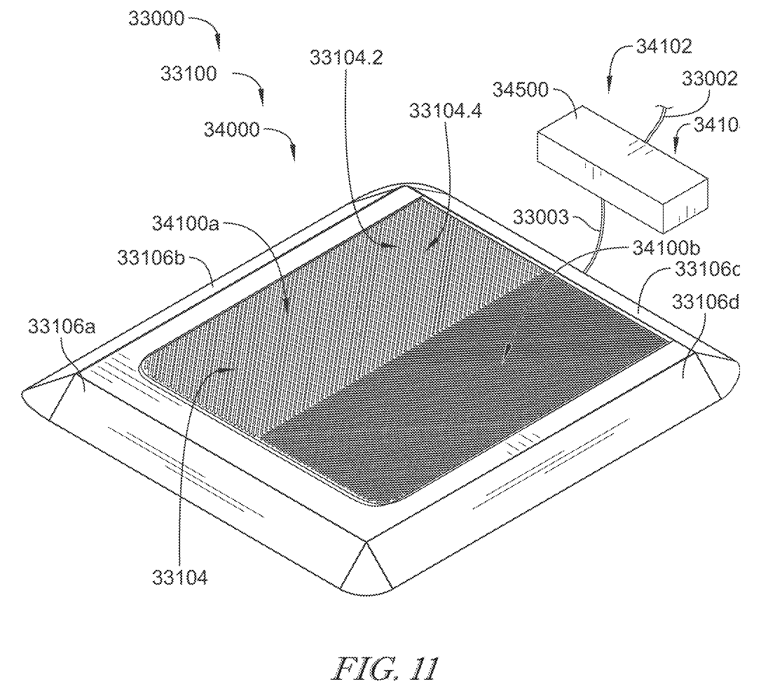

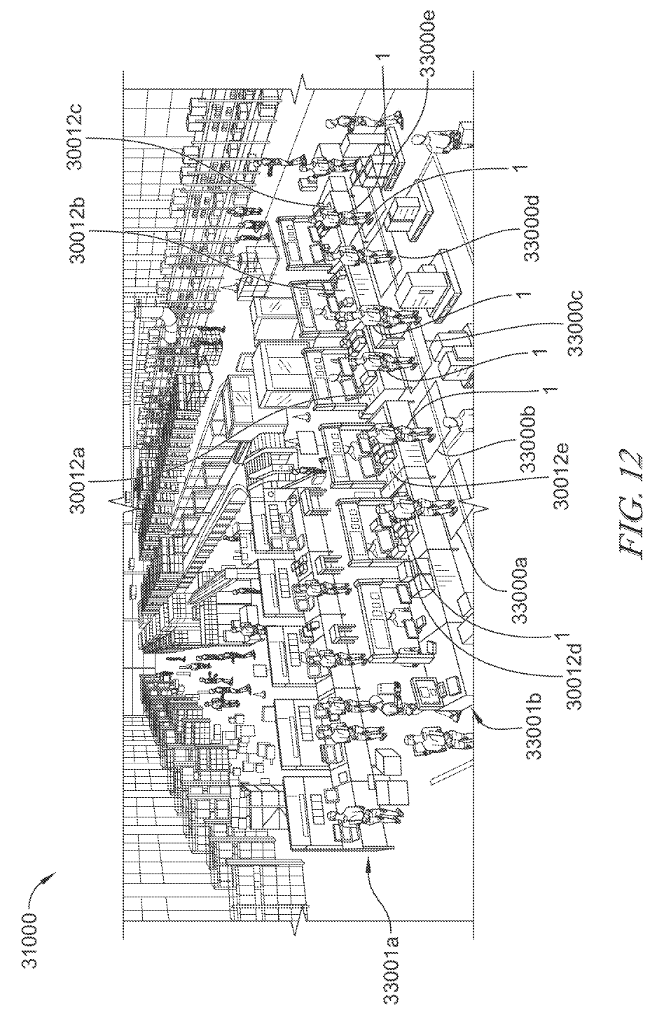

FIG. 12 illustrates a perspective view of a work floor 31000 with opportunity charging systems 33000a-e. The work floor 31000 includes a bank of workstations 30012a-e arranged in a systematic configuration that accommodates both human workers and humanoid robots 1. Multiple opportunity charging systems 33000a-e are strategically positioned throughout the work floor 31000, creating charging bay configurations that enable efficient access to charging capabilities. For example, FIG. 12 illustrates opportunity charging systems 33000a-e creating charging bay 33001b. The opportunity charging systems 33000a-e are arranged in a linear sequence along the charging bay 33001b, allowing multiple humanoid robots 1 to access charging simultaneously without interfering with ongoing work operations. The layout demonstrates how the charging infrastructure may be seamlessly integrated into an industrial or warehouse environment, with the opportunity charging systems 33000a-e positioned to minimize disruption to normal operations while maximizing charging accessibility. The arrangement may facilitate continuous operation by allowing robots 1 to charge in between scheduled breaks or shift changes without disrupting the overall workflow. However the disclosure is not limited to this arrangement and any number of opportunity charging systems may create a charging bay and the opportunity charging systems may be disposed in any configuration within a charging bay. In some embodiments, the work floor 31000 configuration may enable the robots 1 to move between different workstations 30012a-e while accessing charging opportunities at multiple locations. This distributed charging approach may extend operational runtime by allowing robots 1 to receive supplemental power throughout their work cycles rather than requiring dedicated charging periods that remove them from productive activities.

### d. Fourth Embodiment of an Opportunity Charging System

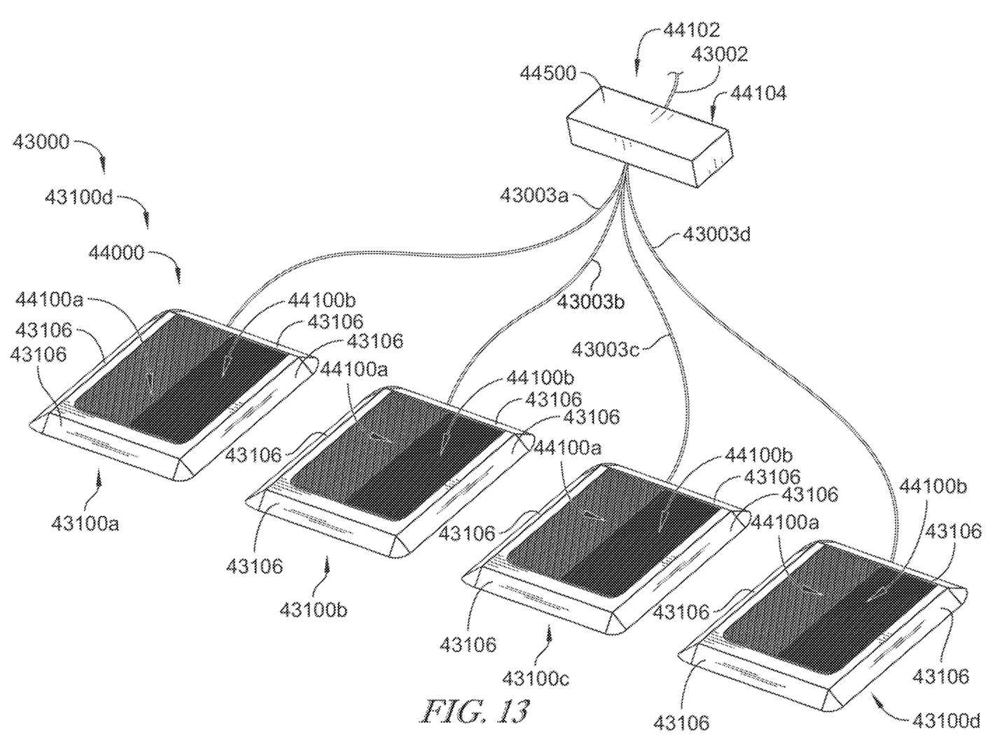

Similar to the charging system 3000 as described above, FIG. 13 illustrates a fourth embodiment of an opportunity charging system 43000 that includes a power conversion unit that contains the electronics associated with multiple charging mat assemblies. For the sake of brevity, the above disclosure in connection with the charging system 3000 will not be repeated below, but it should be understood that across embodiments, like numbers represent like structures. For example, the disclosure relating to WPT system 4000 applies in equal force to WPT system 44000. Further, it should be understood that the operational modes of the opportunity charging system 43000 are similar to, or identical to, those disclosed regarding charging system 3000. Moreover, it is to be understood that any one or more features of the charging system 3000 can be used in conjunction with those disclosed regarding the opportunity charging system 43000, and that any one or more features of opportunity charging system 43000 can be used in conjunction with those disclosed regarding the charging system 3000.

In contrast to the third embodiment of the opportunity charging system 33000 that is described above, this embodiment centralizes electronics in a single power conversion unit for multiple charging mat assemblies. This centralized control architecture may enable one electronics assembly 44500 to manage power distribution and charging operations across several charging mat assemblies 43100a-d through individual tether cords 43003a-d connecting to each charging mat assembly 43100a-d. The centralized configuration may provide enhanced coordination between multiple charging systems, allowing for load balancing, sequential charging schedules, and optimized power management across a charging network. The centralized architecture may also reduce the total number of power supply units deployed on the work floor, which may reduce overall system cost, energy consumption, and maintenance burden.

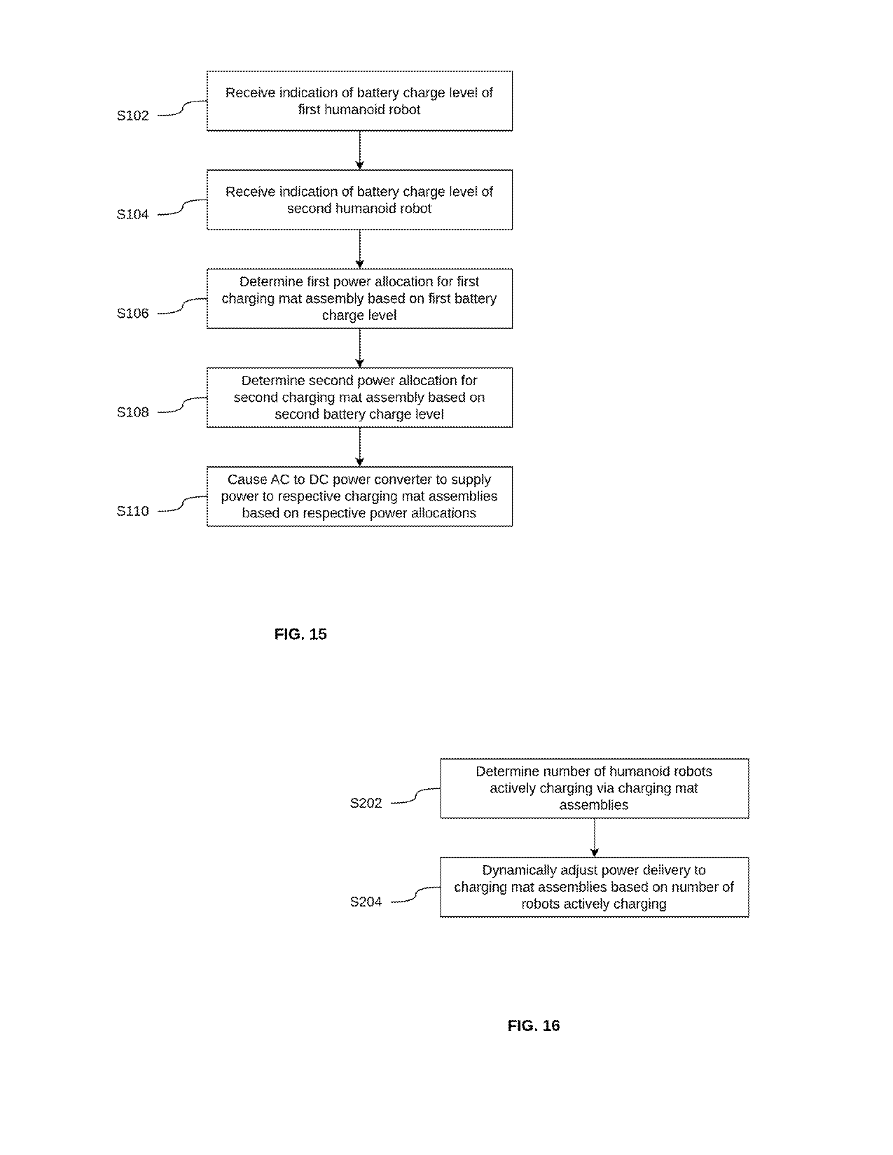

The single electronics assembly 44500 may be configured to communicate with a plurality of the humanoid robots 1. The single electronics assembly 44500 may include multiple output channels, each capable of independently controlling the power delivery to a different charging mat assembly 43100a-d via the respective tether cords 43003a-d in order to charge the respective battery 202 of the robots 1. In some aspects, this multi-channel approach may allow the electronics assembly 44500 to independently control power allocation to each charging mat assembly 43100a-d and simultaneously charge multiple robots 1 at different power levels based on their individual battery states and charging requirements. For example, referring to FIG. 15, the charging controller 44104 may be configured to receive, from each humanoid robot 1 in the plurality of humanoid robots 1, an indication of a battery charge level of each humanoid robot 1 (S102 and S104) and determine a power allocation for each respective charging mat assembly 43100a-d in which the respective humanoid robots 1 are standing based on the respective battery charge levels of the humanoid robots 1 (S106 and S108). Accordingly, power may be supplied to the respective charging mat assembly 43100a-d based on the determined a power allocation for each respective charging mat assembly 43100a-d in which the respective humanoid robots 1 are standing (S110).

In some aspects, referring to FIG. 16, the centralized control system may also enable priority-based charging, where the electronics assembly 44500 can allocate more power to robots 1 with higher priority tasks or lower battery levels. For example, the charging controller 44104 may further be configured to determine a number of humanoid robots 1 actively charging via respective charging mat assemblies 43100a-d (S202) and dynamically adjust power delivery to the respective charging mat assemblies 43100a-d based on the number of humanoid robots actively charging (S204). The dynamic adjustment may include redistributing available power from unoccupied charging mat assemblies 43100a-d to occupied ones, thereby maximizing the charging rate for robots 1 that are present and in need of power.

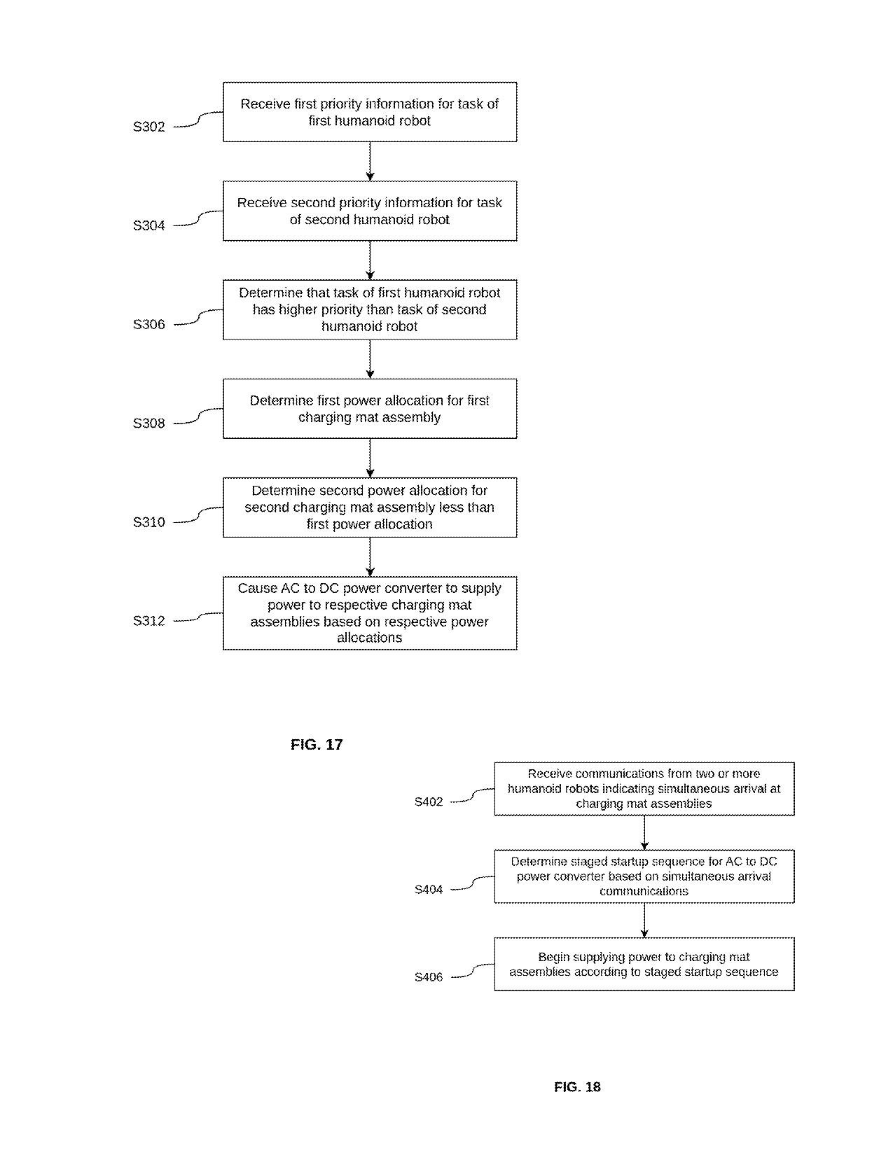

In some aspects, referring to FIG. 17, the controller 44104 may receive respective priority information for tasks of different humanoid robots 1 (S302 and S304) and determine which tasks of the humanoid robots 1 has a higher priority based on the priority information (S306). Accordingly, the controller 44104 may determine the power allocation for the respective charging mat assembly 43100a-d to which the robots 1 are standing based on the priority of the tasks (S308 and S310) to ensure that the highest priority tasks are being completed before lower priority tasks. Thereafter, power may be supplied to the respective charging mat assembly 43100a-d at the respective power allocations (S312). The priority information may be received from a fleet management system, from the robot 1 itself, or from a human operator via a user interface coupled to the electronics assembly 44500.

This multi-system control capability may be particularly advantageous in large-scale deployments where numerous charging mat assemblies 43100a-d are across a work floor (e.g., work floor 31000) or facility. The centralized electronics assembly 44500 may reduce overall system complexity, maintenance requirements, and installation costs compared to deploying individual electronics assemblies for each charging mat assembly 43100a-d. In some cases, the single electronics assembly 44500 may incorporate communication interfaces that allow it to coordinate with fleet management systems, enabling automated scheduling and monitoring of charging operations across multiple robots 1 and opportunity charging mat assemblies 43100a-d.

The centralized electronics assembly 44500 may also enable more efficient utilization of available electrical infrastructure by allowing a single power outlet to support charging operations for more robots than would otherwise be possible with individual opportunity charging systems. The electronics assembly 44500 may incorporate intelligent power management algorithms that prioritize and regulate power delivery to multiple robots simultaneously, dynamically allocating available power based on factors such as battery charge levels, task priorities, and operational schedules. The intelligent power management algorithms may include linear programming, convex optimization, or heuristic scheduling techniques configured to maximize the aggregate charging throughput subject to the constraints of the electrical supply.

In some aspects, the electronics assembly 44500 may include power limiting functionality that monitors and controls the total power draw from a single power outlet to maintain operation below the outlet's power rating. This power management capability may prevent circuit breaker trips and electrical system overloads that could otherwise occur when multiple high-power charging operations are attempted simultaneously. The electronics assembly 44500 may continuously monitor power consumption across all connected charging mat assemblies 43100a-d and automatically adjust charging rates to stay within predetermined power limits. The power limiting functionality may include a current sense resistor or a hall-effect current transducer disposed at the input of the electronics assembly 44500 to provide a continuous measurement of the total input current.

In some aspects, referring to FIG. 18, the electronics assembly 44500 may also incorporate current inrush limiting features to prevent overloading the electrical circuit during startup or when multiple robots begin charging simultaneously. In some cases, the controller 44104 may receive communications from two or more humanoid robots 1 indicating simultaneous arrival at charging mat assemblies 43100a-d (S402) and determine a staged startup sequence based on simultaneous arrival communications (S404). The electronics assembly 44500 may implement staged startup sequences that gradually bring charging mat assemblies online (S406), thereby distributing the initial power demand over time rather than creating sudden current spikes that could trip protective devices or cause voltage drops in the electrical system. The staged startup sequence may include a predetermined delay interval between successive activations of the charging mat assemblies 43100a-d, where the delay interval may be a fixed duration (e.g., 1-5 seconds) or may be dynamically calculated based on the measured input current at the time of each activation. This power management approach may be particularly beneficial in facilities with limited electrical capacity or where adding additional electrical circuits would be costly or impractical. The electronics assembly 44500 may enable improved utilization of existing electrical infrastructure while maintaining safe operating conditions and reducing the likelihood of electrical system disruptions that could affect other equipment or operations in the facility.

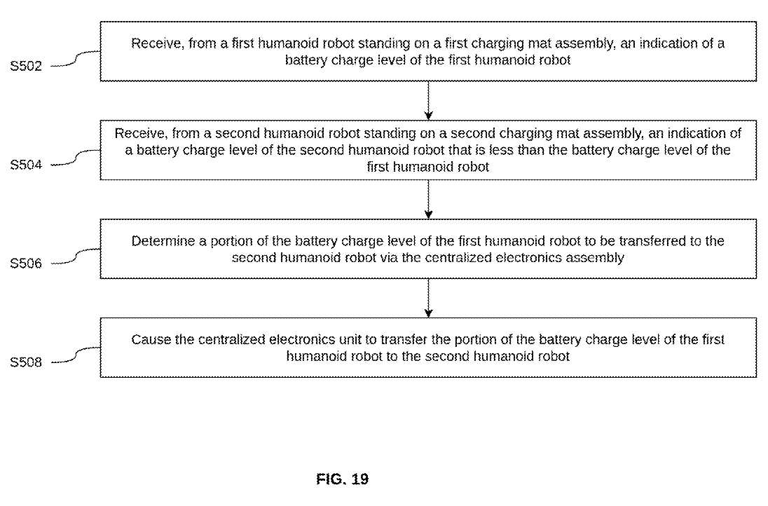

In some aspects, referring to FIG. 19, the controller 44104 may receive an indication of battery charge levels between different robots 1 (S502 and S504) and determine which robot 1 has a lower battery charge level and a portion of the battery charge to be transferred to the robot 1 with the lower battery charge level (S506). Based on which robot 1 has a lower battery charge level, the electronics assembly 44500 may enable a portion of the battery charge level of the robot 1 having a higher battery charge level than the other robot 1 to be transferred to the other robot 1 (S508). This robot-to-robot power transfer may be accomplished by directing the receiver coil assemblies 936a, 936b in one robot 1 to operate in a reverse mode (i.e., as a transmitter) while the transmitter coils 4100a, 4100b in the corresponding charging mat assembly serve as intermediary coupling elements, and the electronics assembly 44500 regulates the direction and magnitude of the power flow.

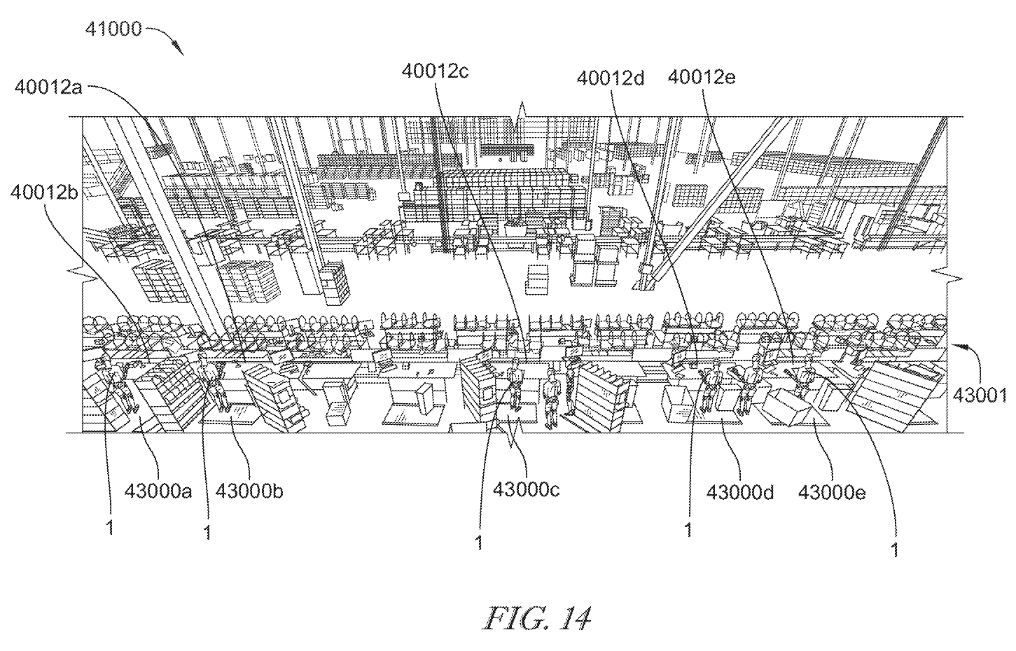

FIG. 14 illustrates a perspective view of another work floor 41000 with workstations 40012a-e, according to aspects of the present disclosure. The work floor 41000 includes a bank of workstations 43001 arranged in a systematic configuration that accommodates both human workers and humanoid robots 1. Multiple workstations 40012a-e are positioned throughout the bank of workstations 43001, creating dedicated areas for specific operational tasks. Several charging systems 43000a-e are integrated into the layout of the work floor 41000, positioned at intervals that provide convenient access for the humanoid robots 1 operating at different workstations 40012a-e. In some implementations, the charging mat assemblies may be similar to those shown in previous figures, such as opportunity charging systems 13000, 23000, and/or 33000, depending on the specific needs of each work station location.

The arrangement shown in FIG. 14 illustrates how the charging infrastructure may be seamlessly integrated into an industrial or warehouse environment, with the opportunity charging systems 43000 positioned to reduce the likelihood of disruption to normal operations while increasing charging accessibility. The workstations 40012a-e may include various types of equipment, workbenches, or processing areas where robots 1 can perform assigned tasks while maintaining proximity to charging capabilities. In some embodiments, the work floor 41000 configuration may enable the robots 1 to move between different workstations 40012a-e while accessing charging opportunities at multiple locations. This distributed charging approach may extend operational runtime by allowing robots 1 to receive supplemental power throughout their work cycles rather than requiring dedicated charging periods that remove them from productive activities.

The perspective view of FIG. 14 demonstrates how the opportunity charging systems 43000a-e may be positioned to serve multiple workstations 40012a-e simultaneously, enabling efficient utilization of the charging infrastructure across the entire work floor 41000. The layout may also accommodate different types of charging scenarios, from brief opportunistic charging during task transitions to longer charging sessions during scheduled maintenance periods. In some embodiments, the positions of the charging systems 43000a-e within the work floor 41000 may be determined by a facility planning algorithm that takes into account factors such as robot traffic patterns, task durations, power consumption profiles, and the locations of available electrical outlets.

### H. ALTERNATIVE EMBODIMENTS

In other possible implementations, alternative power-transfer techniques and configurations may be employed. The power cord 3002 can be configured to be wired directly into an electrical junction box for a more permanent installation. To supplement or replace the primary inductive charging system, a resonant inductive charging system may be incorporated, wherein one or more secondary resonator coils are strategically spaced around or above the flat base platform portion 3102 to enable efficient power transfer even when the robot's feet 92 are separated by a short gap from the surface, thereby increasing the robustness of the charging process. Alternatively, capacitive coupling surfaces may be used, wherein arrays of interleaved capacitive plates are integrated into the charging mat assembly 3100 and cradle arms 3302a, 3302b. In environments that permit a clear line-of-sight, the system may be configured for optical or laser power beaming, wherein the charging system 3000 is integrated with high-power infrared LEDs or laser diodes, and corresponding photovoltaic receiver cells are integrated onto the robot's feet 92 or torso 16.

Variations in thermal management techniques are also contemplated. The charging system 3000 may incorporate air multiplier technology, wherein a high-speed internal fan accelerates a primary airflow that is ejected to induce and entrain a larger volume of ambient air for more effective cooling. The charging mat assembly 3100 can include active air-moving features, such as fans, to either push cool air up toward the robot's feet or draw cool air down and away from the charging coils. In another embodiment, the system may incorporate heat pipes embedded within the charging mat assembly 3100 and support cradle 3300, supplemented by phase-change materials (PCMs), or "thermal batteries," to absorb and slowly release transient thermal peaks, thereby reducing the need for power-intensive active cooling components. In a further embodiment, the thermal management system may include a thermoelectric cooler (TEC) module disposed between the transmitter coil assemblies 4100a, 4100b and the base support plate, configured to pump heat away from the coils and toward a heat rejection surface on the exterior of the base housing.

The charging system 3000 can be equipped with enhanced sensor systems and integrated diagnostics for foreign object detection. Expanded vision-based sensors 3113a, such as additional wide-angle or thermal imaging cameras, can provide the robot 1 with enhanced data for precise alignment and safety monitoring. To mitigate risks associated with inductive charging, an enhanced metallic debris detection system may be employed, using inductive or Hall-effect sensors to detect foreign objects and trigger a self-cleaning mechanism, such as a wiper blade or a directed burst of compressed air. For diagnostics, small cameras, steerable endoscopes, or ultrasonic probes may be mounted within the support cradle 3300 to conduct an automated "health check" of the robot's critical components during a charging cycle. The system could also serve as a calibration fixture, using integrated cameras and lasers to verify the calibration of the robot's own sensor suite (e.g., LiDAR, cameras) while it is held in a known, stable position.

To enhance cyber-physical security and communication, an encrypted docking handshake protocol may be established, requiring mutual authentication using cryptographic keys over a wired or wireless link before enabling power transfer. Following a secure connection, a digital-twin synchronization process may be initiated, wherein the charging system 3000 serves as a high-bandwidth conduit for the robot 1 to exchange its current state data---including sensor logs, operational parameters, and error codes---with its cloud-hosted digital twin, enabling predictive maintenance and remote diagnostics. The charging system 3000 could also function as a local edge computing node, performing initial data processing for the robot 1 or the entire fleet to reduce latency and cloud data transmission loads. The encrypted docking handshake protocol may conform to a public-key infrastructure (PKI) scheme, wherein each robot 1 and each charging system 3000 is provisioned with a unique certificate that is verified during the handshake.

Further embodiments may feature dynamic, mobile, and varied installation configurations to increase operational flexibility. The entire charging system 3000 may be mounted upon an autonomous guided vehicle (AGV), or an overhead gantry or crane system may be utilized, wherein the support cradle 3300 is affixed to a suspended overhead rail. In such mobile embodiments, or in stationary embodiments where grid power may be intermittent, the charging system 3000 may itself be equipped with an internal battery bank. This allows the charging system 3000 to charge its own batteries during off-peak hours or when grid power is available, and subsequently discharge that stored energy into the robot 1, providing charging capabilities even when disconnected from a primary power source. Alternative installation modes include a flush-floor docking pit, wherein the charging mat assembly 3100 is recessed into the floor to eliminate tripping hazards, or wall-mounted and ceiling-suspended units to conserve floor space. For large-scale, fleet-level operations, multiple charging systems 3000 may be arranged in a single, multi-bay charging array governed by a central scheduling system that optimizes fleet charging and balances electrical loads based on predictive algorithms that consider task priority, robot location, and energy consumption patterns. In another collaborative embodiment, the robots 1 themselves may be equipped with short-range inductive power couplers, enabling a fully charged robot 1 to share power directly with a low-battery peer in the field, further enhancing fleet operational endurance.

Further embodiments are envisioned that incorporate alternative components, materials, structures, methodologies, and integrations to enhance performance, expand capabilities, or adapt the system for specific operational contexts. The upper platform of the charging mat assembly may be constructed from a ceramic material such as aluminum nitride (AlN) or silicon carbide (SiC), which are electrically insulating while being highly thermally conductive, allowing the top plate to function as an efficient heat spreader without detuning the electromagnetic field. The charging mat and the soles of the robot's feet may incorporate permanent-magnet inserts, such as a shallow Halbach array, for passive alignment and ensuring a repeatable stance. For enhanced thermal management, thermoelectric (Peltier) spot coolers may be bonded to the heat spreader to provide on-demand "burst" cooling, with heat being rejected to a remote sink. In fixed industrial installations, the active cooling system may be supplemented by a facility-tied cold plate with quick-connect couplings to a main chilled-water loop. To create a flexible and portable charging surface, transmitter coils may be fabricated on a flexible printed circuit board (flex-PCB) with a polyimide substrate, encapsulated in a durable elastomer such as silicone to create a rollable mat. A capacitive sensing grid may also be integrated beneath the top plate to detect the presence, position, and pressure distribution of the robot's feet for alignment guidance or as a safety interlock. Furthermore, heat spreaders may be constructed from graphene-based composite materials for significantly higher thermal conductivity and a thinner profile.

Alternative structural and geometric variations are also contemplated. A flexible, roll-out charging mat may be constructed as a single rollable unit or as a system of interlocking tiles, including active coil tiles and passive spacer tiles, for custom-sized charging areas. The two discrete transmitter coil assemblies could be replaced by a single, elongated transmitter coil spanning both of the robot's feet or configured as a continuous strip along a workbench. A one-foot pylon charger, consisting of a small pedestal with a single transmitter coil, may be used for opportunistic "top-off" charging. The wireless inductive system may be replaced by a galvanic charging system comprising an array of flush, touch-safe conductive micro-studs in the floor surface. For permanent installations, a facility in-floor grid could feature transmitter coil rails installed in the subfloor beneath standard floor tiles. To assist with mechanical alignment, self-centering V-groove heel rails or magnetic toe/heel detents providing a "click-in" sensation could be integrated into the mat surface. The U-shaped support cradle could be replaced by a retractable vertical docking pole rising from the floor or an overhead gantry with a descending support cradle. The charging mat itself may be shaped as a triangle or hexagon to allow for seamless tessellation, and vertically stacked transmitter coils could create a three-dimensional charging volume to tolerate variations in the robot's height. In a further variation, the charging mat may be embedded within a rotating turntable platform that can rotate the robot 1 to a desired orientation after docking, such that the robot 1 faces a workstation or monitoring area without executing a turn under its own power.

Methodological and process alterations can further enhance the system. A receiver-led "ping and home" process may be employed, where the robot excites its own receiver coil at a pilot frequency, and the mat measures reflected impedance to guide alignment. Frequency-multiplexed coils for the left and right feet, operating at distinct ISM frequencies, can mitigate cross-coupling. Time-sliced "walkway charging" could use a sequenced runway of coils that energize only under the robot's feet for continuous trickle charging during locomotion. A thermal budgeting methodology of pre-cool scheduling could chill the heat spreader before a planned high-power burst. Final alignment may be achieved using force-plate-only data from an instrumented mat, eliminating the need for visual systems. A multi-modal docking sequence could use Ultra-Wideband (UWB) for coarse positioning and haptic feedback for final alignment. The system could perform adaptive EMI shaping using near-field probes and feedforward cancellation. An ultra-low-field "sentinel" mode could conserve energy, with a secondary trigger like UWB or capacitive proximity waking the system. A human-presence radar interlock could halt power transfer for safety, and the dock could serve as a metrology station with instrumented pads to calibrate the robot's actuators. Finally, RFID/NFC tags in the robot's soles could simplify identification and allow for per-robot charging profiles. In yet another variation, the system may employ a bi-directional power flow architecture, wherein the battery pack 202 of the robot 1 may discharge energy back through the receiver coil assemblies 936a, 936b and through the charging mat assembly 3100 to the facility power grid, thereby enabling the robot 1 to participate in vehicle-to-grid (V2G) energy management schemes during periods of peak electrical demand.

Additional embodiments focus on integrations and combinations of systems to create a more holistic and intelligent charging system. The charging system may incorporate an integrated boot-cleaning system, where proximity sensors trigger the activation of brushes, scrapers, or directed air jets as the robot approaches. This system proactively removes debris, particularly hazardous metallic shavings or conductive dust, from the soles of the robot's feet before charging commences, thereby preserving the integrity of the charging surfaces and mitigating the risk of foreign object heating. For enhanced safety, especially during high-power charging cycles, the system could be integrated with a building's fire suppression system. Onboard thermal and gas sensors would continuously monitor for the early signs of a thermal runaway event; if a threshold is breached, the system could trigger a highly localized deployment of a fire-extinguishing agent, precisely targeting the robot's battery compartment or the charging mat to neutralize the threat while minimizing collateral damage. The high-bandwidth data link could be implemented using Light Fidelity (Li-Fi) technology, with modulated LEDs integrated into the support cradle and a corresponding optical receiver on the robot. This creates a secure, high-speed, line-of-sight data link that is completely immune to the electromagnetic interference generated by the charging coils, ideal for transferring large data logs or receiving firmware updates. Furthermore, a multi-robot power-sharing protocol could be enabled, allowing a fully charged robot to use the system's power electronics as a controlled intermediary. This system would facilitate the transfer of a portion of its charge to a second, low-battery robot at an adjacent system, governed by a fleet management algorithm that prioritizes energy distribution based on operational needs, thus increasing overall fleet flexibility and resilience.

### I. INDUSTRIAL APPLICATION

In summary the disclosed docking station introduces several advanced features for the autonomous charging and data management of a humanoid robot. The rear-engagement design provides substantial benefits as it unconventionally leaves the robot's forward-facing operational systems, such as sensors and manipulators, entirely unobstructed while securely docked. The support cradle incorporates a funnel-like geometry for passive mechanical guidance and vertical alignment posts that engage with corresponding recesses on the robot, establishing a high-precision kinematic coupling. This coupling ensures a highly repeatable docked position, which is helpful for two key functions: optimizing the efficiency of the wireless power transfer between transmitter coils in the low-profile charging mat and receiver coils in the robot's feet, and enabling a high-bandwidth data offload. The precise mechanical alignment brings a communication transceiver in the support cradle into close proximity with a corresponding transceiver on the robot, facilitating a multi-gigabit wireless connection for the rapid offloading of large datasets. The system further enhances charging efficiency and safety through a communication-aided alignment process, where the station and robot exchange information to make micro-adjustments to the robot's foot placement for optimal coil alignment, and a dynamic power adjustment protocol that uses closed-loop feedback to safely ramp up and regulate charging power. Advanced safety is provided by a multi-modal foreign object detection (FOD) system, which may include inductive sensors for metallic debris and thermal imagers operating a "heat and detect" protocol to identify thermal hazards on the charging surface. Furthermore, the station integrates an active cooling system to manage thermal loads and may, in some embodiments, connect to a data network to intelligently coordinate charging schedules and queues among multiple robots and docking stations.

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut -shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data.This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US26/13952, PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. Patent Application Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, and 19/252,708; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A charging system for a plurality of humanoid robots, the charging system comprising:
a plurality of charging mat assemblies, wherein each charging mat assembly includes at least one transmitter coil assembly configured to generate an oscillating magnetic field for wireless power transfer to a humanoid robot when the humanoid robot stands on the charging mat assembly; and
a centralized electronics assembly coupled to each charging mat assembly in the plurality of charging mat assemblies via a respective tether cord, the centralized electronics assembly comprising:
a communications transceiver configured to communicate with the plurality of humanoid robots;
an AC to DC power converter configured to supply power to the plurality of charging mat assemblies via the respective tether cords; and
a controller configured to independently control power allocation from the AC to DC power converter to each charging mat assembly in the plurality of charging mat assemblies.

2. The charging system of claim 1, wherein the controller is configured to:
receive, from a first humanoid robot in the plurality of humanoid robots, an indication of a battery charge level of the first humanoid robot;
receive, from a second humanoid robot in the plurality of humanoid robots, an indication of a battery charge level of the second humanoid robot;
based on the battery charge level of the first humanoid robot, determine a first power allocation for a first charging mat assembly on which the first humanoid robot is standing;
based on the battery charge level of the second humanoid robot, determine a second power allocation for a second charging mat assembly on which the second humanoid robot is standing, wherein the second power allocation is different from the first power allocation; and
cause the AC to DC power converter to supply power to the first and second charging mat assemblies based on the respective first and second power allocations.

3. The charging system of claim 1, wherein the controller is configured to:
determine a number of humanoid robots actively charging via respective charging mat assemblies in the plurality of charging mat assemblies; and
based on the number of humanoid robots actively charging, dynamically adjust power delivery to one or more of the respective charging mat assemblies.

4. The charging system of claim 1, wherein the controller is configured to:
receive, from a first humanoid robot in the plurality of humanoid robots, first priority information for a task of the first humanoid robot;
receive, from a second humanoid robot in the plurality of humanoid robots, second priority information for a task of the second humanoid robot;
based on the first priority information and the second priority information, determine that the task of the first humanoid robot has higher priority than the task of the second humanoid robot; and
based on determining that the task of the first humanoid robot has higher priority than the task of the second humanoid robot:
determine a first power allocation for a first charging mat assembly on which the first humanoid robot is standing;
determine a second power allocation for a second charging mat assembly on which the second humanoid robot is standing, wherein the second power allocation is less than the first power allocation; and
cause the AC to DC power converter to supply power to the first and second charging mat assemblies based on the respective first and second power allocations.

5. The charging system of claim 1, wherein the controller is configured to:
receive, from two or more humanoid robots of the plurality of humanoid robots, respective communications that collectively indicate that the two or more robots will arrive at respective charging mat assemblies for wireless charging substantially simultaneously; and
based on the communications indicating that the two or more robots will arrive at respective charging mat assemblies for wireless charging substantially simultaneously, determine a staged startup sequence for the AC to DC power converter to begin supplying power to the respective charging mat assemblies .

6. The charging system of claim 1, wherein the controller is configured to:
receive, from a first humanoid robot in the plurality of humanoid robots that is standing on a first charging mat assembly, an indication of a battery charge level of the first humanoid robot;
receive, from a second humanoid robot in the plurality of humanoid robots that is standing on a second charging mat assembly, an indication of a battery charge level of the second humanoid robot that is less than the battery charge level of the first humanoid robot;
identify an amount of current to be transferred from the first humanoid robot to the second humanoid robot via the centralized electronics assembly; and
cause the centralized electronics assembly to transfer the identified amount of current from the first humanoid robot to the second humanoid robot.

7. The charging system of claim 1, wherein each charging mat assembly in the plurality of charging mat assemblies is deployed within a workstation for a humanoid robot such that a humanoid robot can execute a task within the workstation while standing on the charging mat assembly.

8. The charging system of claim 7, wherein the charging system is deployed within a working environment comprising a plurality of workstations for humanoid robots, the plurality of workstations forming a charging bay wherein each workstation in the plurality of workstations comprises a respective charging mat assembly.

9. The charging system of claim 1, wherein each charging mat assembly includes beveled edges on at least three sides of the charging mat assembly, wherein the beveled edges provide ramped surfaces configured to allow a humanoid robot to approach the charging mat assembly from multiple directions.

10. The charging system of claim 1, wherein each charging mat assembly comprises a flat base platform portion defining a wireless charging surface, and wherein the at least one transmitter coil assembly comprises two transmitter coil assemblies positioned beneath the wireless charging surface in a side-by-side configuration corresponding to a neutral stance of left and right feet of the humanoid robot.

11. The charging system of claim 10, wherein the wireless charging surface includes a textured surface comprising grooves and projections configured to provide a high-friction contact surface for the feet of the humanoid robot.

12. The charging system of claim 1, wherein each charging mat assembly includes an uppermost surface and a lowermost surface, and wherein the distance between said surfaces is less than or equal to 8 inches.

13. The charging system of claim 1, wherein the controller is configured to:
monitor power consumption across all charging mat assemblies in the plurality of charging mat assemblies; and
based on monitoring the power consumption across all charging mat assemblies in the plurality of charging mat assemblies, automatically adjust a supply of power to one or more charging mat assemblies to maintain total power consumption within a predetermined power consumption limit.

14. An opportunity charging system for wirelessly charging a humanoid robot, the opportunity charging system comprising:
a base housing having a wireless charging surface and at least one ramped edge extending from the wireless charging surface, wherein the at least one ramped edge is configured to reduce a lift height of a foot of a humanoid robot to step onto the wireless charging surface;
a first transmitter coil assembly and a second transmitter coil assembly positioned within the base housing beneath the wireless charging surface, wherein the first transmitter coil assembly and the second transmitter coil assembly are spaced apart in a side-by-side configuration corresponding to a neutral stance of left and right feet of a humanoid robot, and wherein the first transmitter coil assembly and the second transmitter coil assembly are each configured to generate an oscillating magnetic field for wireless power transfer to a respective receiver coil assembly in a respective foot of the humanoid robot;
a tether cord extending from the base housing; and
an electronics assembly that is physically separate from the base housing and coupled to the base housing via the tether cord, wherein the electronics assembly comprises power conversion electronics configured to supply power to the first transmitter coil assembly and the second transmitter coil assembly via the tether cord.

15. The opportunity charging system of claim 14, wherein the base housing comprises a ramped edge extending from at least three sides of the wireless charging surface, the ramped edge is configured to allow a humanoid robot to step onto the wireless charging surface from multiple directions with the reduced lift height of the foot of the humanoid robot.

16. The opportunity charging system of claim 15, wherein the one ramped edge comprises a plurality of ramped edges surrounding an entire perimeter of the wireless charging surface, and
wherein the plurality of ramped edges includes a front ramped edge having a more gradual slope than the other of the plurality of ramped edges.

17. The opportunity charging system of claim 16, wherein the base housing has a height that is less than or equal to 8 inches.

18. The opportunity charging system of claim 14, wherein the first transmitter coil assembly and the second transmitter coil assembly are positioned such that respective centers of the first transmitter coil assembly and the second transmitter coil assembly are spaced apart by a distance of between 150 mm and 400 mm.

19. The opportunity charging system of claim 14, wherein the wireless charging surface includes a textured surface comprising grooves and projections configured to provide a high-friction contact surface for the feet of the humanoid robot.

20. The opportunity charging system of claim 14, wherein the first transmitter coil assembly comprises a first geometry that is shaped to correspond to a first foot of a humanoid robot, and wherein the second transmitter coil assembly comprises a second geometry that is shaped to correspond to a second foot of a humanoid robot.

21. The opportunity charging system of claim 14, wherein the first transmitter coil assembly comprises a first coil that is wound in a first direction, and wherein the second transmitter coil assembly comprises a second coil that is wound in a second direction opposite the first direction, such that a respective magnetic field generated by the first coil and the second coil substantially cancel out far-field emissions.
